(19) United States
(12) Patent Application Publication
(10) Pub. No.: US 2026/0073514 A1
(43) Pub. Date: Mar. 12, 2026

(54) METHODS AND SYSTEMS FOR IMAGE-TO-IMAGE TRANSLATION OF MICROSCOPY IMAGES

(71) Applicant: Diffine LLC, San Diego, CA (US)

(72) Inventors: Nikola ANDREJIC, Nis (RS); Ivana MIKIC, San Diego, CA (US); Milica SPASIC, Nis (RS); Igor MIHAJLOVIC, Nis (RS); Petra MILOSAVLJEVIC, Nis (RS); Danilo DELIBAŠIC, Nis (RS); Sinisa TODOROVIC, Corvallis, OR (US)

(21) Appl. No.: 19/322,309

(22) Filed: Sep. 8, 2025

Related U.S. Application Data
(60) Provisional application No. 63/692,545, filed on Sep. 9, 2024.
(60) Provisional application No. 63/805,764, filed on May 14, 2025.
(60) Provisional application No. 63/831,034, filed on Jun. 26, 2025.

(51) Int. Cl. G06T 7/00

(52) U.S. Cl. CPC G06T 7/0012; G06T 2207/10056; G06T 2207/10064; G06T 2207/20081; G06T 2207/20084; G06T 2207/30024; G06T 2207/30204

(57) ABSTRACT

Described herein are methods and systems for training image to image translation machine-learning models, wherein the image to image translation machine-learning models are trained using unpaired images. The trained image to image translation machine-learning models can be used to digitally identify markers of a fluorescent image depicting a plurality of markers in a single color channel from a single fluorophore and/or enhance a fluorescence image.

### CROSS-REFERENCE TO RELATED APPLICATIONS

This application claims benefit under 35 U.S.C. § 119(e) of U.S. Provisional application 63/692,545, filed Sep. 9, 2024, U.S. Provisional application 63/805,764, filed May 14, 2025, and U.S. Provisional application 63/831,034, filed Jun. 26, 2025, the disclosure of each of which are incorporated herein in their entirety.

### BACKGROUND

Digital image processing with artificial intelligence and machine-learning has led to significant advances in histopathology and other fields. Domain adaptation—a machine-learning technique—increases generalizability and transferability of models from one dataset to another, and thus allows for new applications in histopathology and biological research. In domain adaptation, models trained on one dataset (e.g., legacy, old histopathology images) are conveniently adapted to work on a new, different dataset (e.g., image illumination and colors may differ from those in the legacy dataset). One group of domain-adaptation approaches directly modify the models to increase generalizability, whereas another group modifies images of the new dataset to look similar to images in the legacy dataset and keeps the models intact. The latter domain-adaptation group of approaches uses image-to-image translation, which takes images of the new dataset at the input and creates artificial images at the output that look like images of the legacy dataset. The models are expected to perform well on the newly generated artificial images since the models have been trained on the legacy dataset.

In some examples of digital image processing in histopathology and in other forms of biological sample imaging, deep learning models have been used for stain normalization to reduce variability in staining protocols between different facilities. In another example, domain adaptation has been used to train models to perform nuclei segmentation, which is important in cancer diagnosis and other clinical/research applications. In further examples, image-to-image translation methods have been used in stain transfer to translate a microscopy image to a different type of stain or to virtually stain an unstained tissue sample.

In traditional histopathology as an exemplary field, pathologists examine tissue samples to identify abnormalities, diagnose diseases, and guide treatment decisions. Digital histopathology represents a process of imaging, digitizing and analyzing microscopic images of tissue samples, where artificial intelligence (AI) tools are used to analyze the images and in this way aid pathologists in their work. Main components of a digital histopathology system include image staining and acquisition (imaging process), digital conversion, storage and management, analysis and interpretation of scanned images.

There are many challenges commonly facing digital pathology and other biological image processing fields. One challenge is the prohibitively large amount of time needed to manually annotate objects of interest in the images (i.e. one million nuclei), which is needed to provide supervision for training A1 models for the image analysis. Another challenge is human error and a significant disagreement among different experts in providing annotations or making the final decisions based on the images. A third challenge is that there are only small datasets available relative to some other domains that use A1. For example, only a small number of tissue slides are typically available for a certain dataset due to medical and biological conditions of the study. A further challenge is unbalanced datasets, where often the images show tissues with a high probability of illness, but a small number of slides show healthy tissue. Unlabeled datasets are also a challenge, as it is often prohibitively costly to manually label every instance of objects of interest in tissue slides.

A particular problem in training image-to-image translation methods is the difficulty in obtaining high quality paired training images. Paired training images would aid the machine-learning models in deciphering the sample content from the domain style. Obtaining paired training images would require imaging of a single sample in multiple domains which is often difficult or impossible based on the imaging technology available. In general, it is impractical and expensive to re-stain tissues and/or cells and thus it is difficult to generate paired images. Depending on the imaging technique, one tissue sample can only be stained once, but it is often desirable to stain the very same tissue sample with other stains. For instance, one stain may color only one phenotype of cells of interest, whereas the diagnosis may require identification of multiple distinct phenotypes, or, for instance, images from one or both domains may be from tissue samples that are no longer available.

Models that can be trained with unpaired images have been used for image analysis when paired images are not available. These models, including CycleGAN models suffer from various technical problems making them impractical for biomedical applications. When applied to biological images, the models often produce hallucination artifacts. Thus, the images that are produced using some unpaired machine-learning methods are of low quality. Some models require large amounts of data, computing and memory resources that make them impractical for use in scientific experiments and in clinical settings.

Accordingly, there is a need for image-to-image translation models that do not require paired training images yet are still able to produce high quality results with reasonably low resource costs. Such updates would be usefully both for histopathology and other biological sample imaging.

Continued developments in processing of histopathology images can improve the speed and accuracy of analyzing tissue samples, thereby improving the diagnosis and treatment of various diseases and medical conditions.

### SUMMARY

In some aspects, described herein are methods and systems comprising machine-learning modes for image to image translation and methods and systems for training the machine-learning models. The machine-learning models described herein are trained using unpaired training images.

Provided herein are methods for digitally identifying markers for a fluorescence image depicting a plurality of markers, comprising: receiving the fluorescence image, wherein the plurality of markers are represented in a single color channel from a single fluorophore; and identifying the plurality of markers in the fluorescence image by inputting the fluorescence image into a trained machine-learning model, wherein the trained machine-learning model is trained with a plurality of training single-channel fluorescence images and a plurality of training marker-separated fluorescence images, and wherein the plurality of training single-channel fluorescence images and the plurality of training marker-separated fluorescence images are unpaired.

Also provided herein are methods for enhancing a fluorescence image depicting a one or more markers and a background signal, comprising: identifying the background signal by inputting the fluorescence image into a trained machine-learning model, wherein the trained machine-learning model is trained with a plurality of training positive fluorescence images depicting the one or more markers and fluorescence background signal and a plurality of training negative fluorescence images depicting fluorescence background without the one or more markers, and wherein the plurality of training positive fluorescence images and the plurality of training negative fluorescence images are unpaired; and enhancing the fluorescence image by removing the identified background signal form the fluorescence image.

Also provided herein are methods for enhancing a fluorescence image depicting one or more markers, comprising: receiving the fluorescence image; and generating an enhanced fluorescence image by inputting the fluorescence image into a trained machine-learning model, wherein the machine-learning model is trained using a training dataset comprising a plurality of enhanced training fluorescence images depicting the one or more markers and a plurality of unenhanced training fluorescence images depicting the one or more markers, wherein the plurality of enhanced training fluorescence images and the plurality of unenhanced training fluorescence images are unpaired.

Also provided herein are methods of training a machine-learning model, the methods comprising: obtaining a training dataset comprising a plurality of training single-channel fluorescence images and a plurality of training marker-separated fluorescence images, wherein the plurality of training single-channel fluorescence images and the plurality of training marker-separated fluorescence images are unpaired; and training, based on the training data, the machine learning model configured to receive an fluorescence image depicting a plurality of markers represented in a single color channel from a single fluorophore and output a marker-separated fluorescence image, depicting each marker in the plurality of markers in a respective color channel.

Also provided herein are methods of training a machine-learning model, the methods comprising: obtaining a training dataset comprising a plurality of training positive fluorescence images depicting one or more markers and fluorescence background signal and a plurality of training negative fluorescence images depicting fluorescence background without the one or more markers, wherein the plurality of training positive fluorescence images and the plurality of training negative fluorescence images are unpaired; and training, based on the training data, the machine learning model configured to receive a fluorescence image depicting the one or more markers and a background signal and identify the background signal.

Also provided herein are methods of training a machine-learning model, the methods comprising: obtaining a training dataset comprising a plurality of enhanced training fluorescence images depicting one or more markers and a plurality of unenhanced training fluorescence images depicting the one or more markers, wherein the plurality of enhanced training fluorescence images and the plurality of unenhanced training fluorescence images are unpaired; and training, based on the training data, the machine learning model configured to receive a fluorescence image depicting the one or more markers and output an enhanced fluorescence image.

Also provided herein are systems comprising: one or more processors; and a non-transitory memory coupled to the one or more processors comprising instructions that, when executed by the one or more processors, cause the one or more processors to perform the steps of any one of the methods described herein.

Also provided herein are systems for digitally identifying markers for a fluorescence image depicting a plurality of markers, comprising: one or more processors; and a non-transitory memory coupled to the one or more processors comprising instructions that, when executed by the one or more processors, cause the one or more processors to receive the fluorescence image, wherein the plurality of markers are represented in a single color channel from a single fluorophore; and identify the plurality of markers in the fluorescence image by inputting the fluorescence image into a trained machine-learning model, wherein the trained machine-learning model is trained with a plurality of training single-channel fluorescence images and a plurality of training marker-separated fluorescence images, and wherein the plurality of training single-channel fluorescence images and the plurality of training marker-separated fluorescence images are unpaired.

Also provided herein are systems for enhancing a fluorescence image depicting a one or more markers and a background signal, comprising: one or more processors; and a non-transitory memory coupled to the one or more processors comprising instructions that, when executed by the one or more processors, cause the one or more processors to: identify the background signal by inputting the fluorescence image into a trained machine-learning model, wherein the trained machine-learning model is trained with a plurality of training positive fluorescence images depicting the one or more markers and fluorescence background signal and a plurality of training negative fluorescence images depicting fluorescence background without the one or more markers, and wherein the plurality of training positive fluorescence images and the plurality of training negative fluorescence images are unpaired; and enhance the fluorescence image by removing the identified background signal form the fluorescence image.

Also provided herein are systems for enhancing a fluorescence image depicting one or more markers, comprising: one or more processors; and a non-transitory memory coupled to the one or more processors comprising instructions that, when executed by the one or more processors, cause the one or more processors to: receive the fluorescence image; and generate an enhanced fluorescence image by inputting the fluorescence image into a trained machine-learning model, wherein the machine-learning model is trained using a training dataset comprising a plurality of enhanced training fluorescence images depicting the one or more markers and a plurality of unenhanced training fluorescence images depicting the one or more markers, wherein the plurality of enhanced training fluorescence images and the plurality of unenhanced training fluorescence images are unpaired.

Also provided herein are systems of training a machine-learning model, the systems comprising: one or more processors; and a non-transitory memory coupled to the one or more processors comprising instructions that, when executed by the one or more processors, cause the one or more processors to: obtain a training dataset comprising a plurality of training single-channel fluorescence images and a plurality of training marker-separated fluorescence images, wherein the plurality of training single-channel fluorescence images and the plurality of training marker-separated fluorescence images are unpaired; and train, based on the training data, the machine learning model configured to receive an fluorescence image depicting a plurality of markers represented in a single color channel from a single fluorophore and output a marker-separated fluorescence image, depicting each marker in the plurality of markers in a respective color channel.

Also provided herein are systems of training a machine-learning model, the systems comprising: one or more processors; and a non-transitory memory coupled to the one or more processors comprising instructions that, when executed by the one or more processors, cause the one or more processors to: obtain a training dataset comprising a plurality of training positive fluorescence images depicting one or more markers and fluorescence background signal and a plurality of training negative fluorescence images depicting fluorescence background without the one or more markers, wherein the plurality of training positive fluorescence images and the plurality of training negative fluorescence images are unpaired; and train, based on the training data, the machine learning model configured to receive a fluorescence image depicting the one or more markers and a background signal and identify the background signal.

Also provided herein are systems of training a machine-learning model, the systems comprising: one or more processors; and a non-transitory memory coupled to the one or more processors comprising instructions that, when executed by the one or more processors, cause the one or more processors to: obtain a training dataset comprising a plurality of enhanced training fluorescence images depicting one or more markers and a plurality of unenhanced training fluorescence images depicting the one or more markers, wherein the plurality of enhanced training fluorescence images and the plurality of unenhanced training fluorescence images are unpaired; and train, based on the training data, the machine learning model configured to receive a fluorescence image depicting the one or more markers and output an enhanced fluorescence image.

### BRIEF DESCRIPTION OF THE DRAWINGS

The patent or application file contains at least one drawing executed in color. Copies of the patent or patent application publication with color drawing(s) will be provided by the Office upon request and payment of the necessary fee.

FIGS. 1A-1B show schematics and images of immunofluorescence techniques, as known in the art. FIG. 1A illustrates use of two fluorophores. FIG. 1B illustrates use of one fluorophore.

FIG. 2A shows an input immunofluorescence image before digital marker identification, and FIG. 2B shows an image following digital marker identification, in accordance with some embodiments.

FIGS. 3A and 3B show exemplary digitally separated images, in accordance with some embodiments. FIG. 3A shows input fluorescence images and corresponding digitally marker separated images. FIG. 3B shows input fluorescence images (left column), corresponding digitally marker separated images (middle column), and training multi-channel images (right column).

FIGS. 4 and 5 are block diagrams of the training and inference procedures of the image-to-image translation system of the present disclosure, in accordance with embodiments.

FIG. 6 is a simplified schematic diagram of a CycleGAN system, in accordance with some embodiments.

FIG. 7A shows image translation using a conventional CycleGAN (Cycle Consistent Generative Adversarial Network) architecture.

FIG. 7B shows image translation using systems and methods of the present disclosure, in accordance with some embodiments.

FIGS. 8A and 8B are block diagrams showing training of the model to model image translation systems described herein. FIG. 8A is a detailed block diagram of training an image translation model in autoencoder mode for use in fluorescence image marker identification, in accordance with some embodiments. FIG. 8B is a detailed block diagram of training an image translation model in translation mode for use in fluorescence image marker identification, in accordance with some embodiments.

FIGS. 9A-9D are example images from domains A and B, in accordance with some aspects. FIG. 9A is an exemplary image of domain A. FIG. 9B is an exemplary image of domain B₁ paired. FIG. 9C is an exemplary image of domain B₂ semi-paired.

FIG. 9F is an exemplary image of domain B₃ unpaired.

FIG. 10 is a block diagram of a training flow, in accordance with some aspects.

FIGS. 11A-11B are schematic block diagrams of training and inference regimes of image-to-image translation systems and methods, in accordance with some aspects. FIG. 11A shows an exemplary block diagram of training. FIG. 11B shows an exemplary block diagram for inference.

FIG. 12 shows example results of 121 translation applied to domain adaptation, in accordance with some aspects.

FIG. 13 shows example results of 121 translation applied to unsupervised nuclear segmentation, in accordance with some aspects.

FIGS. 14A-14B illustrate image focus enhancement and image resolution enhancement, in accordance with some aspects. FIG. 14A shows an exemplary out of focus and virtually focused image. FIG. 14B shows an exemplary low resolution and virtually enhanced image.

FIG. 15 shows example results of 121 translation applied to photorealistic stylization of artificially generated images, in accordance with some aspects.

FIGS. 16A-16B illustrate unpaired image-to-image translation for signal (e.g., background) removal, in accordance with some aspects. FIG. 16A shoes exemplary images with and without DAPI. FIG. 16B shoes exemplary reference image examples from an exemplary training dataset.

### DETAILED DESCRIPTION

Methods and systems are described herein that enable training of machine-learning models (e.g., image to image (I2I) translation models) without the need for paired training images. The methods and systems can be used for inferring a domain change for an image, including but not limited to, digitally identifying markers for fluorescence images depicting a plurality of markers in a single color channel. The translation systems can advantageously decouple image style from image content. The digital images may be microscopy images, such as but not limited to for histopathology. The microscopy images may be, for example, nuclear, tumor, tissue, or cell, membrane images. While histopathology shall be used as an example in this disclosure, the techniques and systems can be applied to other types of analyses of microscopy images or other digital images.

As a non-limited example, in traditional histopathology, pathologists examine tissue samples to identify abnormalities, diagnose diseases, and guide treatment decisions. Digital histopathology represents a process of imaging, digitizing and analyzing microscopic images of tissue samples, where artificial intelligence (A1) tools are used to analyze the images and in this way aid pathologists in their work. Main components of a digital histopathology and or other biological imaging system include image staining and acquisition (imaging process), digital conversion, storage and management, analysis and interpretation of scanned images.

There are many challenges commonly facing digital pathology and other biological sample imaging fields. One challenge is the prohibitively large amount of time needed to manually annotate objects of interest in the images (i.e. one million nuclei), which is needed to provide supervision for training A1 models for the image analysis. Another challenge is human error and a significant disagreement among different experts in providing annotations or making the final decisions based on the images. A third challenge is that there are only small datasets available relative to some other domains that use A1. For example, only a small number of tissue slides are typically available for a certain dataset due to medical and biological conditions of the study. A further challenge is unbalanced datasets, where often the images show tissues with a high probability of illness, but a small number of slides show healthy tissue. Unlabeled datasets are also a challenge, as it is often prohibitively costly to manually label every instance of objects of interest in tissue slides. Finally, although one of skill would like to train models using paired images, tissues, in general, usually cannot be re-stained and thus it is impractical or impossible to generate paired images. Depending on the imaging technique, one tissue sample can only be stained once, but it is often desirable to stain the very same tissue sample with other stains. For instance, one stain may color only one phenotype of cells of interest, whereas the diagnosis may require identification of multiple distinct phenotypes.

The methods and systems described herein allow for training of machine-learning models for biological sample imaging the challenges described above. The methods described herein do not rely on human annotation, they can be trained on a small number of images, and they do not require paired images for training.

Various technical improvements to machine-learning models are implemented as described herein to perform high quality image to image translation without paired images. As described herein, several technical improvements are made to a CycleGAN model architecture for use in image to image translation with histology images. The technical improvement both enhance the inference results for the trained machine-learning models and enhance training methods to decrease the computing resources and time needed for training the models. Spectral normalization decreases computational complexity and reduces training time. As additional advantage, spectral normalization eliminates stitching artifacts, when inference is executed on image patches that are then stitched together.

In some embodiments, feature based normalization is removed and a hallucination resistant alternative method is applied to prevent hallucinations while preserving cellular and medical features. The spectral normalization techniques applied in the methods and systems described herein decrease the computing resources and time needed to train the models.

In some embodiments, UNet architectures are used for the generators. The skipped connections of the UNet architecture leads to better content and local features preservation. The skipped connections also preserve and propagate shallow, localized features through the depth of the network, enhancing spatial fidelity in the output. The UNet models applied in the methods and systems described herein decrease the computing resources and time needed to train the models.

In some embodiments, the generators of the CycleGAN model are stacked allowing sharing of weights at the bottleneck between the encoders and decoders and allowing for a single stacked discriminator. This modification prevents overfitting and improves computational efficiency. The modification also decreases computing resources and the time needed to train the models.

The technical improvements to the CycleGAN architecture described herein improve training speed and efficiency, allowing for training of the image to image translation models for domain specific translations in parallel with software already used for processing fluorescently labeled images.

As described herein, the methods and systems described herein can be used for domain translations and enhancing of fluorescently labeled images. In some embodiments, the images are fluorescence images. In some embodiments, the images are immunofluorescence (IF) images. Immunofluorescence (IF) is an immunochemical technique for imaging tissue samples that allows cell detection and localization in the resulting IF images. Compared to immunohistochemistry (IHC), IF allows for excellent sensitivity and amplification of the cell-relevant signal. The IF technique conjugates an antibody to a fluorophore—the process called staining—and the position of the target biomolecule is visualized by exciting the fluorophore and measuring the emission of light using a microscope. It is often advantageous to apply multiple markers on a single tissue sample, and in this way allow a comprehensive study of cell configuration, functionality, and cell-to-cell interactions. These multi-marker methods are advantageous for viewing multiple markers but the methods require expensive technology and are limited in the number of markers that can be assessed based on the number of fluorescence imaging channels of the microscope. The methods and systems described herein reduce the need for expensive fluorescent imaging technologies because multiple markers can be captured using a single fluorophore in a single channel and computational methods can be used to separate the channels computationally.

As described herein, the applications of the image to image translation systems extend beyond digitally identifying markers. In non-limiting examples, the methods can be used for single channel to multiple channel translation and/or single channel to single channel translations. Examples of single channel to single channel applications include translation of images obtained under traditional experimental conditions to ideal conditions. Ideal conditions may comprise using the best, expensive reagents; long exposure time; best channel (lowest autofluorescence, etc.); higher resolution, and may not be practical for large scale experiments. Thus, the translation may allow for generation of higher quality large scale imaging without increasing costs and time associated with high performance imaging.

### A. Methods and Systems for Digitally Identifying Markers

The methods and systems described herein can be used for digitally identifying markers in fluorescence images depicting a plurality of markers in a single color channel from a single fluorophore. The image translation machine-learning model is trained to translate images from a domain wherein multiple markers have been imaged with the same fluorescent marker and are imaged in the same channel (superimposed) to a domain wherein the markers are digitally separated into multiple channels, using unpaired training images. The trained machine-learning model can receive an image with a first marker and a second marker depicted in a single color channel from a single fluorophore and output the marker-separated image. The marker separated images depict the plurality of markers in separate color channels. In some embodiments, this process may be called unmixing.

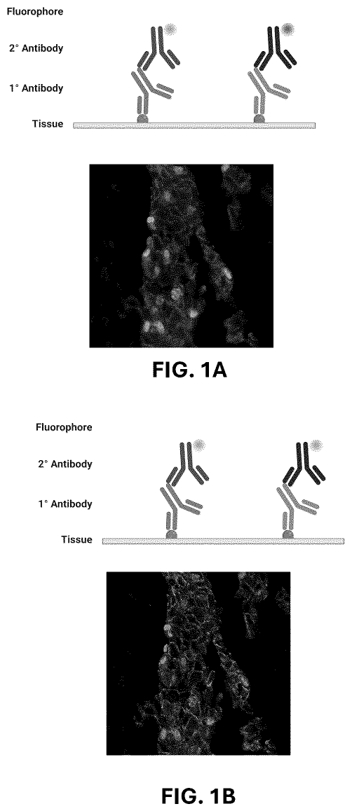

FIG. 1A illustrates the way that different subcellular structures are stained in standard IF by using multiple markers and multiple fluorophores. In standard IF, different fluorophores (fluorophore 1 and fluorophore 2) with distinct colors (green and red in this example) are used to stain the corresponding distinct parts of the cell structure (e.g., nucleus and cytoplasm of cells) in a tissue sample. This standard IF method produces multiple, distinct color channels of a standard IF image, where each color channel corresponds to one fluorophore color used. Due to spectral overlap, the number of distinct fluorophores that can be used in a single sample is always limited (to usually less than six).

FIG. 1B illustrates an fluorescence with two markers and a single fluorophore. The process involves applying two secondary antibodies into the same imaging channel by using the same fluorophore (fluorophore 1) on two different secondary antibodies that are staining distinct subcellular structures. That is, a single fluorophore is used to stain all cell parts of interest in a tissue sample, resulting in a single-color fluorescence image. The resulting IF (IF) image consists of only one color channel.

The main advantage of fluorescence imaging with multiple markers and a single fluorophore compared to fluorescence imaging that the multi-marker, single-fluorophore per marker fluorescence imaging reduces staining and imaging costs and increases the information content relative to those of standard fluorescence imaging because the capacity of an assay can be significantly increased.

Innovations in the present disclosure are aimed at digitally identifying distinct markers imaged in a single color channel to visualize different cell parts of interest in a given single-color fluorescence imaging image at the input (shown in FIG. 1B) and in this way generate a corresponding standard fluorescence imaging (i.e., multi-marker, multi-fluorophore) image at the output. That is, the present methods and systems aid in identifying separate distinct cell parts of interest into individual color channels. A key innovation is digitally identifying markers imaged in a single color channel from the input fluorescence imaging image, e.g., to separate each color channel into multiple single-marker images and in this way facilitate the subsequent A1 analysis of the fluorescence image.

Another key concept is a new deep-learning architecture, and a new training procedure for this architecture for image to image (I2I) translation for digitally identifying markers on a fluorescence image imaged in a single color channel from a single fluorophore and other image translation tasks as described herein. The other image translation tasks include but are not limited to removing background signal and enhancing images.

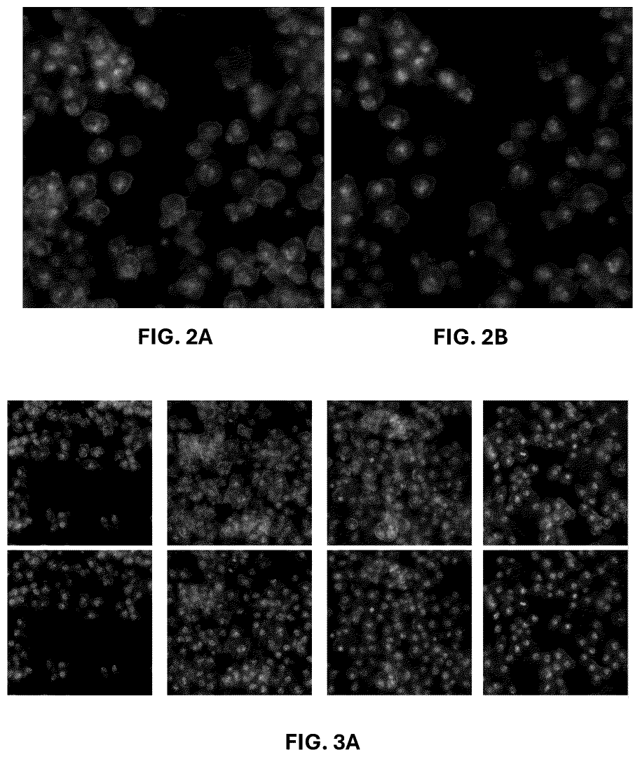

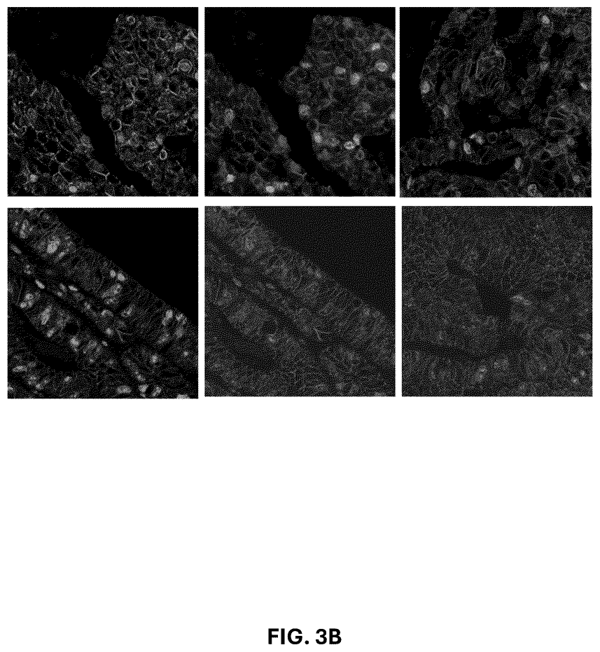

FIGS. 2A-2B show example results achieved with the present methods and systems. FIG. 2A shows an input fluorescence image before digitally identifying the markers, and FIG. 2B shows the fluorescence image after the markers are identified with distinct color channels (red and green) as an output of the present techniques. In FIG. 3A, the top row shows input fluorescence images, and the bottom row shows the corresponding output images that consist of two color channels (red and green). These figures demonstrate how a plurality of makers in a single-channel, standard fluorescence image can be digitally identified by the present systems and methods so that different types of cell features can be analyzed.

FIG. 3B provides an additional example of results of the 121 translation system trained for the task of marker identification of fluorescence images depicting a plurality of markers in a single color channel from a single fluorophore. Specifically, the task involves separating multiple distinct markers tagged with the same fluorophore of an input single channel image (left column) into the corresponding multiple color channels each depicting an individual marker (middle column, “marker separated”). For visualization purposes, in the fluorescence images, multiple channels are displayed together using red and green colors for each separated color channel. As described herein the image to image translation may be referred to as translating an image from a first domain to a second domain. As applied in FIG. 3B, the first domain comprises single-channel images and the second domain comprises marker-separated images. In training, the first domain has single channel fluorescent images, where two distinct markers are visualized using a single fluorophore, resulting in a single-channel image (green in this example). The second domain contains fluorescence images, where the same two biomarkers are labeled with separate fluorophores, producing two distinct fluorescence channels (red and green in this example). The results can be qualitatively compared with the ground-truth multi-marker fluorescence image of the second domain (right column, “reference marker separated training image”) for evaluation.

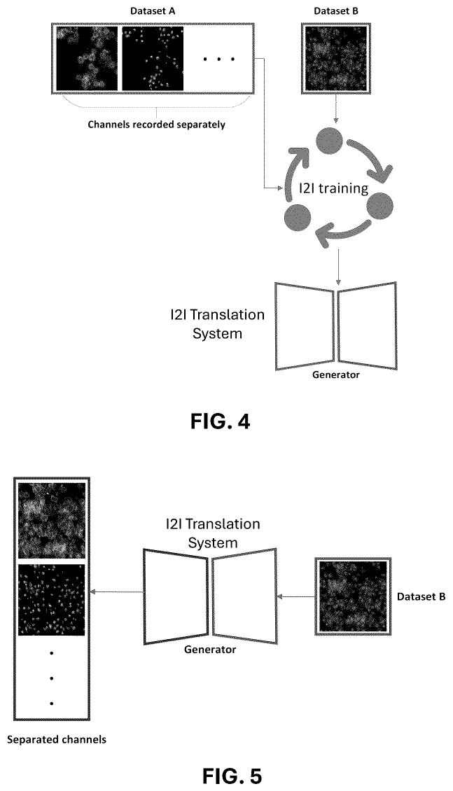

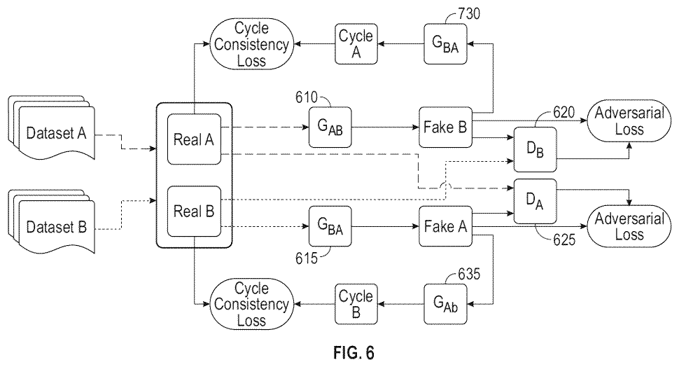

As described herein, the methods and systems of the present disclosure are trained utilizing two datasets of unpaired fluorescence images. Image-to-image translation systems are described for marker identification in an input fluorescence image by generating a fluorescence image wherein each marker is, each represented by a single color channel. Paired images are images with the same ground truth and pixel to pixel alignment. The term unpaired means images that are not paired. In some embodiments, unpaired means that the two datasets of images do not need to show the same tissue samples. For example, a dataset containing fluorescence images (e.g., with both cytoplasmic and nuclear stains imaged in a single image channel) shall be called the superimposed dataset, or may also be referred to in this disclosure as a data corpus. A marker-separated dataset contains multichannel fluorescence images such that each image channel represents a distinct single stain corresponding to the one present in the superimposed dataset. The present image-to-image (I2I) translation system is trained on these two datasets to learn the unpaired translation between superimposed and marker separated images. Then in inference, new test fluorescence images (i.e., target images) are run through the trained 121 translation system (i.e., image-to-image translation model or image-to-image translator) that includes a generator neural, which outputs the corresponding digitally separate versions that represent multiple markers in multiple channels. An overview of the training and inference procedures of the 121 system is shown in FIGS. 4 and 5, respectively. FIG. 4 is a block diagram of a training procedure of the image-to-image translation system for digitally identifying markers in fluorescence images, in accordance with some embodiments. The dataset A contains fluorescence images where each color channel corresponds to one fluorophore. The dataset B contains IF images where the markers used for staining in dataset A were used for staining but with only one fluorophore. 121 training is performed using the datasets A and B, with the result being a trained image-to-image translation model having a generator neural network (Generator).

In embodiments, a system for training an image-to-image translation model for fluorescence images includes a data corpus having a first dataset of images of fluorescence staining, wherein the first dataset of images contain marker images in separate channels; a dataset having target images (which may also be referred to as test images or input images) with fluorescence staining, wherein the target images depict multiple markers in a single channel; and a training procedure designed to train a generator neural network to translate the target images into corresponding translated images that depict multiple markers in separate color channels. The generator neural network preserves an object geometry of the target images in the translated images. The generator neural network, after being trained, is an image-to-image translation model.

FIG. 5 is a block diagram of an inference procedure of the present disclosure, with a fluorescence image given at the input. In inference, the dataset B contains target images that are single-color fluorescence images (as described in FIG. 1B) that are to be separated into multiple channels. FIG. 5 shows that after markers are digitally identified by the 121 translation system, the input fluorescence image is separated into multiple single-color images, where each color corresponds to a particular cellular structure of interest.

In some embodiments, a system for identifying markers for fluorescence images includes an image-to-image translation model that is trained on unpaired data to translate single-channel target images into translated images that are multi-channel, while preserving an object geometry of the target images.

In some embodiments, the 121 system is symmetrical. Accordingly, image translation can proceed in either direction during the inference stage. The use of target image as described herein is non-limiting to an image in either domain of the training images.

The 121 module (i.e., 121 translation system) aims to translate an input image to another image that looks similar to images of a selected dataset in the data corpus (i.e., dataset A of FIG. 4). Since the input image belongs to an unlabeled dataset B, the goal of the 121 module is to translate images from dataset B to the “style” (i.e., single color channels) of dataset A. In this disclosure dataset B consists of multiplexed images, so the term demultiplexing shall be used synonymously with translation from domain B (superimposed) to domain A (separated).

The methods and systems can be used, for example, to image 8 markers in 4 channels. To apply the models for an 8 marker experiment (M1-M8) the following exemplary and non-limiting methods can be used. Given pairs of markers that can be imaged together, M1+M2, M3+M4, M5+M6 and M7+M8 and four microscope colors/channels (C1-C4), the data sets can be generated using the best possible staining and imaging. For example, channels C3 and C4 have the least autofluorescence from the tissue being imaged.

The data sets could be, A1: M1 imaged in C3 and M2 imaged in C4, A2: M3 imaged in C3 and M4 imaged in C4, A3: M5 imaged in C3 and M6 imaged in C4, and B4: M7 imaged in C3 and M8 imaged in C4. A target dataset, B, can be generated using a 4 color experiment with 8 probes, 4 pairs for each color, C1: M1+M2, C2: M3+M4, C3: M5+M6, and C4: M7+M8. Four versions of the 121 translation model described herein can be trained for separation of each pair of markers from each channel of the 4-color experiment:
Translation B-C1 to A1: translates M1+M2 to M1, M2
Translation B-C2 to A2: translates M3+M4 to M3, M4
Translation B-C3 to A3: translates M5+M6 to M5, M6
Translation B-C4 to A4: translates M7+M8 to M7, M8.

### B. Image to Image Translation Model Architecture and Training

In some embodiments, the image-to-image translation model utilizes a deep neural network, such as a CycleGAN. That is, in some embodiments the training procedure is performed using a CycleGAN. Importantly, the neural network (e.g., CycleGAN) is configured to not change the content of the target image (e.g., all objects and their layout are preserved), since the goal is to preserve biological fidelity across image domains. That is, the intrinsic properties (e.g., number of cells, cell shape, cell size and cell location/spatial layout) of the image in one domain are exactly preserved. Instead, the image's style (e.g., color, illumination) are changed to look like those in the other domain, e.g., dataset A.

Advantageously, the 121 module does not change the biological content during translation. That is, all the objects present in the original image, their layout, their geometry and texture remain unperturbed when translating.

A main challenge in translating the target image (from dataset B) to a translated image in the style of a reference image (from dataset A) is disentangling the image content and style. There is no mathematically rigorous definition of content and style of an image, since it is tightly related to human perception. Two observers may not agree on what constitutes the style and what constitutes the content of an image. One of skill in the art would recognize elements and style may be unique to the experiment and/or sample. Accordingly, content and style as used here may refer to the features that are shared between images in two domains and content that is not shared between the two domains, respectively.

For exemplary purposes, content may defined as objects (such as nuclei, vessels, etc.) appearing in the image, whose shape, spatial layout and number of occurrences must be preserved in image-to-image translation. For brevity, in some embodiments, content is considered to be about object geometry. In some embodiments, these features are shared between images in the two domains. Style is defined as a particular level of optical noise, sharpness of edges, brightness, color appearance of objects and background in the image. In some embodiments, these features are unique between domains.

In the present case of identifying markers in a single-channel fluorescence image, it is desired to modify the style of the input fluorescence image such that the single-color input image is transformed into multiple color channels, while preserving the content. Since the goal is to identify markers in fluorescence images that come from a domain without ground-truth annotations (i.e., dataset B), it is not possible to explicitly specify the image content that the network is supposed to preserve. This presents a challenge that is not straightforward to solve from conventional techniques. Using 121 translation for identifying markers is an atypical situation—the content are all biological structures that are captured on an image, and the marker identification of the style(s) must delineate whether this content is represented in a single channel or in multiple channels. Therefore, a key innovation of the present disclosure is in designing a new network architecture and its corresponding training procedure aimed at identifying and preserving the image content.

In general, training of a neural network model is a procedure aimed at learning parameters of a model from training data. Training data typically have ground-truth annotations. Loss is a difference between the model's prediction and ground truth for a training data sample. Training seeks to minimize loss on all training data, and in this way optimally learn model parameters, such that the model produces output which is minimally different from the ground truth.

In the field of generative models, generative adversarial networks (GANs) are one type of model that trains two neural networks (NNs) simultaneously. One NN generates an image (i.e., is a generator), and the other NN works as a discriminator to classify an image as real or fake. In some embodiments, the neural network is an artificial neural network (ANN) The discriminator is trained using real, ground-truth data and also using images generated by the generator. The generator and the discriminator work in an adversarial relationship, where the generator incurs a penalty if the discriminator identifies a fake (i.e., false) image that is produced by the generator. The network is configured with one feedback loop between the discriminator and the real dataset, and another feedback loop between the generator and the discriminator. Using an adversarial loss based on the discriminator's and the generator's performances, the GAN is able to learn and thereby improve the generation of images closer to the real images.

CycleGAN is a type of GAN that solves unpaired image-to-image translation by introducing two GANs, each generating images in one of the domains and a cycle consistency loss in the training procedure. This cycle consistency loss ensures that an original input image that goes through the full forward cycle of the network (which translates from X to Y and then back to X) is reconstructed properly at the end. It is well known in the industry that this cycle consistency loss does not ensure the preservation of object geometry even for the most salient objects in the intermediate image Y. That is, it is possible to have a perfect reconstruction X-to-Y-to-X, but for Y to have significantly different content from X. The two main manifestations of this possibility are geometric distortions of objects in A or steganography where whole objects in domain X are encoded in a global high frequency pattern in domain Y. Some architectures and training procedures of CycleGAN are more prone to these problems than others. Because the intermediate stage (real image translated into the style of domain A) in the present disclosure of practical interest is use cases described herein, it is important to solve this issue of content preservation in the intermediate stage.

In the present disclosure, the CycleGAN (or other translation framework being used) is designed so that the biological content during translation is not changed. That is, all the objects present in the original image, and their layout and their geometry, must remain unperturbed when undergoing marker identification. Conventional CycleGANs are known to struggle with preserving the content, such as “hallucinating” new objects in the image. Therefore, conventional off-the-shelf CycleGANs cannot be used for the present purposes. Instead, in the present systems and methods CycleGANs are extended in an innovative way in terms of both deep architecture and training procedure, as described herein.

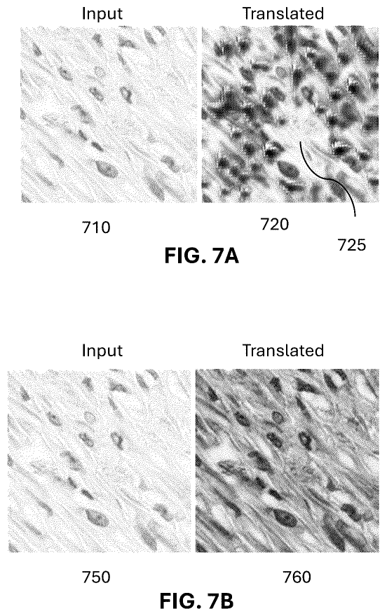

FIG. 6 is a schematic overview diagram of a CycleGAN system for an image-to-image translation model. The image-to-image translation model comprises a generator neural network configured to receive the target images and to generate the translated images. Two generators (i.e., generator neural networks) are utilized, each of which uses input from one of two datasets as a real image. A first generator 610 (G_{AB}) is configured to take an image from dataset A (“real A”) and generate a fake image similar to (in the style of) a domain of dataset B (“fake B”). A second generator 615 (G_{B}A) is configured to take an image from dataset B (“real B”) and generate a fake image similar to (in the style of) a domain of dataset A (“fake A”). Two discriminators (i.e., discriminator neural networks) are also used. A first discriminator 620 (D_{B}) compares fake B to a real image from dataset B (“real B”), while a second discriminator 625 (D_{A}) compares fake A to a real image from dataset A (“real A”). Discriminator 620 then classifies the generated image (fake B) from generator 610 as being a real image or a false image. Similarly, discriminator 625 classifies the generated image (fake A) from generator 615 as being a real image or a false image. The generators of the two adversarial networks (e.g., G_{BA} generators 615 and 630) are identical to each other, with the same structure and weights.

Each discriminator produces an adversarial loss based on output from the discriminator. The adversarial loss is a loss function that shall be described later in this disclosure. The cycle consistency loss for each generator loop analyzes the loss for an image that is translated back to the original dataset format. For example, in cycle A, the cycle consistency loss is for a real A converted (by generator 610, G_{AB}) to fake B and then converted back (generator 630, G_{BA}) to an image in domain A. In cycle B, the cycle consistency loss is for a real B converted (by generator 615, G_{BA}) to fake A and then converted back (generator 635, GAB) to an image in domain B.

After the training is completed on all the desired combinations of translations between datasets A (from data corpus A) and datasets B, the generator G_{BA} (e.g., either generator 615 or generator 630) can be used as an image-to-image translation model.

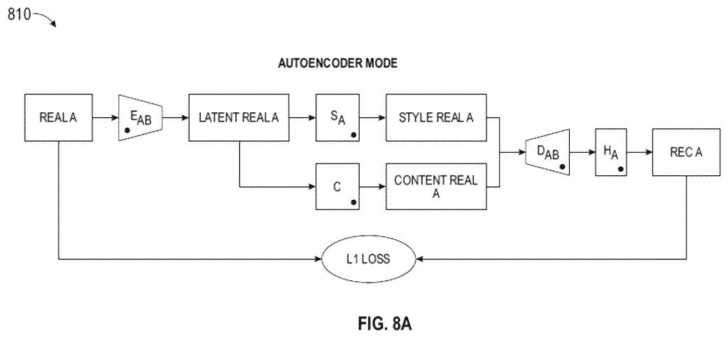

As described herein, the conventional CycleGAN architecture can result in hallucinations and image distortion when applied for image to image translation. FIGS. 7A-7B provide an example of how the conventional CycleGAN architecture distorts image content, using IHC and hematoxylin-and-eosin (H&E) for illustrative purposes instead of fluorescence. FIG. 7A shows results from a conventional CycleGAN applied to the brightfield image translation, with an input image 710 from IHC domain, and an image 720 translated to H&E domain. Both extreme steganography and image content distortion can be seen in the translated image 720, such as shapes being distorted, and artificial features being embedded in the image (area 725).

FIG. 7B shows results using an image translation model of the present disclosure, showing an input image 750 from IHC domain, and an image 760 translated to H&E domain. It is evident that the image content in the translated image 6760 is much better preserved (comparing image 750 to image 760) than in FIG. 7A (comparing image 710 to image 720).

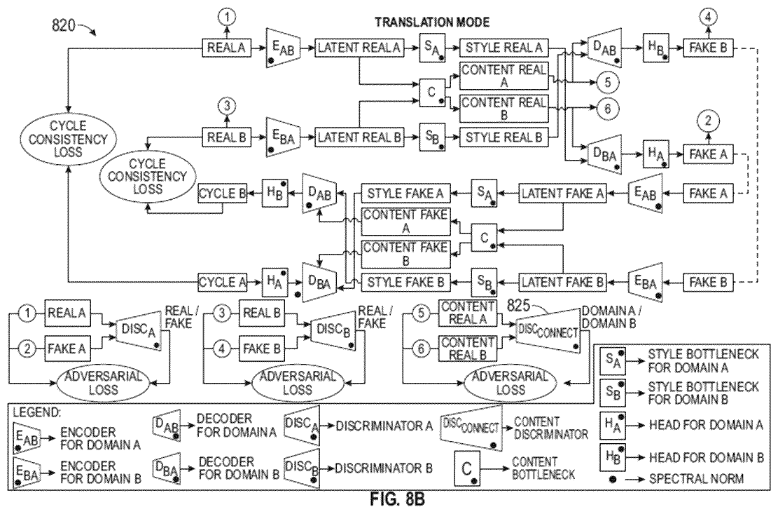

FIG. 8 is a non-limiting detailed block diagram of a training procedure of an image translation system (e.g., image translation system for marker identification), in accordance with some embodiments. Images/feature maps have thinner borders than modules. Each generator can be trained in two modes: an autoencoder mode and a translation mode. Training in the autoencoder mode may be used for improving the generator's ability to reconstruct the original input image. Training in the translation mode is for improving the generator's ability is to translate the image to a different domain. FIG. 8 provides exemplary block diagrams for training the model in autoencoder mode, 810, and in translation mode, 820. In some embodiments, the system is trained by training in autoencoder mode, 810, for each of the unpaired datasets (e.g., shown in FIG. 8 as A and B), and in translation mode, 820 to facilitate effective image translation between the unpaired datasets. Only one version of 810 is illustrated in FIG. 8, it is understood that the system may comprise training a mirrored version for the other domain. The system comprises a technically improved version of the cycleGAN architecture in FIG. 6 for image translation applications. The technical updates and advantages in FIG. 8 compared to FIG. 6 are described herein.

As shown in FIG. 8, to facilitate disentanglement of content and style, generators (i.e., generator neural networks) are modified by splitting them into several modules. Each generator comprises an encoder, two bottlenecks (one for style and one for content), a decoder and a head that generates the final output. Since there are two generators, we have two encoders, two decoders, two style bottlenecks, and two heads, but only one content bottleneck which is always shared to enforce content preservation. That is, one generator neural network comprises a style bottleneck and a content bottleneck, and a second generator neural network has a second style bottleneck and is sharing the content bottleneck with the other generator. As described herein, style and content can be used to refer to what is unique and shared, respectively between images. For illustrative purposes, domain A images are superimposed images where the same fluorophore was used for two markers and domain B images are separated/stacked images from different channels, wherein different fluorophores were used for each marker. As described herein, the training images for domain A and domain B are unpaired images. Accordingly, there are no images in domain A that are paired with an image in domain B.

810 provides a non-limiting example of the autoencoder mode of the image translation system. The system comprises a single U-Net generator. A real image from domain A (e.g., real A) is fed into a domain A encoder, E_{AB}. Image real A is an image from domain A, wherein a single fluorophore was used for two markers and imaging was done in a single channel. The domain A encoder outputs a latent representation of the image that can be fed into the bottleneck blocks, here S_{A} and C to generate deconvoluted content and style embeddings to be fed into the domain A decoder, D_{AB}. The data from domain A decoder, DAB, feeds into a head, H_{A} to generate a recreated version of A. The real A and reconstructed A are compared and a loss, L1 loss, is calculated. The model is trained by modifying the model weights to minimize L1 loss. As shown in 810, E_{AB}, S_{A}, C, and D_{AB} are convolutional neural networks. For each layer of each neural network, spectral normalization is used, for example, bidirectional spectral normalization. The spectral normalization methods applied to the neural networks in FIG. 8 are depicted as dots in the block. For simplicity of the block diagram, the skipped connections between the encoder and decoder that are characteristic of the U-Net architecture, are not represented.

The encoder outputs a latent representation of the image that can be fed into the decoders, here S_{A} and C to generate deconvoluted content and style embeddings to be fed into the decoder, D_{AB}. The data from decoder, D_{AB}, feeds into a head, H_{A} to generate a recreated version of A. The real A and reconstructed A are compared and a loss, L1 loss, is calculated. The model is trained by modifying the model weights to minimize L1 loss.

A similar version of 810, is trained for domain B. Image real B is an image from domain B, wherein two fluorophores were used for the two markers and imaging was done in two channels. For domain B, a real B image, is fed into domain B encoder E_{BA}. Real B image is an image from domain B, here for example, an image with two fluorophore was used for the two markers and imaging in two separate channels. The domain B encoder outputs a latent representation of the image that can be fed into the bottleneck blocks, here S_{B} and C to generate deconvoluted content and style embeddings to be fed into the domain B decoder, D_{BA}. The data from decoder, D_{BA}, feeds into a head, H_{B} to generate a recreated version of B. The real B and reconstructed B are compared and a loss, L1 loss, is calculated. The model is trained by modifying the model weights to minimize L1 loss.

820 provides a non-limiting example of the translation mode of the image translation system. Translation mode 820, comprises a cycle with forward translation and a backward translation and three discriminators. Starting with the forward translation, the system comprises two U-Net generators connected through a shared bottleneck. Image real A is fed into domain A encoder, E_{AB} to generate latent representations of the image. Image real A is an image from domain A, wherein a single fluorophore was used for two markers and imaging was done in a single channel. Image real B is fed into the domain B encoder, E_{BA} to generate latent representations of the image. Image real B is an image from domain B, wherein two fluorophores were used for the two markers that were represented in A and a separate imaging channel was used for each fluorophore. Image A and B share the same markers, but are not images of the same sample, i.e., they are unpaired.

The latent representations from real images A and B are fed into stacked bottleneck blocks. As depicted in 820, latent real A is fed into S_{A} and C, and latent real B is fed into S_{B} and C. As described herein, the stacked bottleneck blocks can distinguish the content (i.e., what is shared between images in A and B) and style (i.e., what is unique to images in A and images in B). The content from real A and real B can be fed into a content discriminator, 825. Content discriminator (Disc Content), 825, is a convolutional neural network. Like the other convolutional neural networks in the system, each layer uses bidirectional spectral normalization. As further depicted in 820, the content from real image A and the style from style real B are fed into a domain A decoder (D_{AB}). The data from domain A decoder, D_{AB}, feeds into a head, H_{B} to generate a fake version of image B. The content from real image B and the style from style real A are fed into a domain B decoder (D_{BA}). The data from the domain B decoder, D_{BA}, feeds into a head, H_{A} to generate a fake version of image A. Fake image A (2) and real image A (1) are fed into a discriminator neural network (Disc_{A}). Fake image B (4) and real image B (3) are fed into a discriminator neural network (Disc_{B}). Both Disc_{A} and Disc_{B} are convolutional neural networks and the layers are normalized using bidirectional spectral normalization. The discriminators (Disc_{A}, Disc_{B}, and Disc Content) are each trained by minimizing an adversarial loss function.

Using single-channel fluorescence images as domain A and separate fluorophore images for domain B, the fake images can be described as follows. Fake image B depicts the biological sample of image A with a separate fluorophore representing both markers and fake image A depicts the biological sample of image B with superimposed fluorophores in one channel representing the two markers. The fake images from the forward translation part of the system are fed into the backwards translation part of the system. Like forward translation, the backwards translation architecture comprises two U-Net generators connected through a shared bottleneck. Fake image B (4) is input into the domain B encoder (E_{BA}) to generate a latent representation of fake image B. Fake image A (2) is input into the domain A encoder (E_{AB}) to generate a latent representation of fake image A. The latent representations for Fake images A and B are fed into bottleneck blocks S_{A}, C, and S_{B} as described in the forward translation. The output from S_{A} (style fake A) and the fake B content are input into a domain B decoder, D_{BA}. The data from the domain B decoder, D_{BA}, feeds into a head, H_{A} to generate a recreated version of image A (cycle A). The output from S_{B} (style fake B) and the fake A content are input into a domain A encoder, D_{AB}. The data from the domain A encoder, DAB, feeds into a head, H_{B} to generate a recreated version of image B (cycle B). A cycle consistency loss is calculated both based on real image A compared to the recreated image A (cycle A) and real image B compared to recreated image B (cycle B). For simplicity of the block diagram, the skipped connections between the encoders and decoders of the forward and reverse generators are not drawn.

In some embodiments, the autoencoder modes and translation mode are trained together or in parallel. In some embodiments, training in both modes comprises, first, in the autoencoder mode 810, an image from domain A (“real A”) is run through an encoder (E_{AB}) for domain A. Next, the features are recombined by the decoder (DAB) for domain A, and the final image is generated (“rec A”) by the head (H_{A}) for domain A. This image is supposed to be as similar as possible to the input image (“real A”). In some embodiments, the process is repeated for domain B.

In the translation mode 820, an image (“real A”) from domain A is run through an encoder (E_{AB}) for domain A, then the features extracted by this encoder are disentangled by content bottleneck and style bottleneck for domain A. However, now the decoder (D_{AB}) for domain A recombines the content features of the image from domain A with style features of image from domain B and finally, the head (H_{B}) for domain B produces the translated image from A to B. This image was reconstructed from content representation of the input image A and with style representation from domain B.

Cycle consistency, as in the original CycleGAN, means that when translating the same image twice, the process should arrive back at the original image.

The framework has one additional discriminator called a content discriminator 825 (Disc_{CONTENT}). This discriminator takes as inputs the content features extracted by the content bottleneck and learns to classify whether the content comes from the image from domain A or the image from domain B. On the other hand, in an adversarial manner, the generative part of the model tries to produce the content features that are indistinguishable between the domains by the content discriminator. In other words, they try to produce content features that are shared between the two domains.

Further details regarding 810, 820, and 825 as well as how the technical features are implemented to improve the image translation model are described herein.

Key innovations that make image content consistent in the present CycleGAN-based image-to-image translation as shown in FIG. 8 include (1) identifying the reason why the conventional CycleGAN fails to preserve image content in image-to-image translation, and (2) changing these elements of the conventional CycleGAN system with more suitable computational modules.

An insight of the present systems and methods is identification of the batch/instance normalization layer as the main culprit for the failure to preserve the image content. The batch/instance normalization layer is used in the conventional setup of a neural network (e.g., CycleGAN) and normalizes each feature map in the neural network. As illustrated in FIG. 8, all of the encoders, decoders, bottleneck blocks, and discriminators comprise convolutional neural networks that would traditionally comprise feature normalization layers. In some embodiments, one or more feature normalization layers of any number of the convolutional neural networks can be removed and/or replaced. The normalization layer works in the case of the standard setup because the content used in previously problems studied is uniform within the domains. For example, for a face-to-sketch translation, all images in the domain A contain exactly one face centered in every image, and the sketch contains exactly one sketch of the face centered in the sketch image.

However, in the present case of some digital images, such as microscopy images, patches vary significantly in their content. That is, microscopy images (or other biomedical images) present new problems that are not encountered in other types of images. For example, the distribution of the number of nuclei per patch is fat tailed—there can be anywhere from zero to hundreds of nuclei per fixed patch size with non-negligible probability, and the network must work uniformly well on all these patches. For this reason, the present systems and methods advantageously drop the batch/instance dependent normalization layers from the network and instead normalize weights. Put another way, previous approaches normalize the data, whereas the present approaches normalize the network weights themselves. The system learns the weights and normalizes them, which serves to constrain the weights during the learning process to reduce the amount of varying that occurs for the weights during training. Normalizations are sometimes referred to as reparametrizations or parametrizations. In some examples, spectral normalization is used. Spectral normalization (which shall be described in more detail later in this disclosure) can provide improved performance and can speed up and stabilize the training. Spectral normalization in the present systems and methods is used for normalizing weights, where a particular formula is applied to a weight “w” that is not normalized to produce a normalized weight norm(w).

Two types of replacements for the batch/instance normalizations may be used in the present disclosure. In a first type of replacement, a normalizing feature is used in the generators, which maps to statistics of a virtual batch (also called reference batch) for generator networks. This is a fixed batch of images chosen before training that is representative of the whole dataset. In some examples, two virtual batches may be chosen, one for each domain (dataset A and dataset B). The virtual batch normalization serves to normalize data (not network parameters) that are input to the network, based on a select set of representative data samples from dataset A. Although virtual batch normalization is a known technique, it has not been used in training of CycleGANs.

An advantage of this first type of replacement is the fact that with correct choice of the virtual batch, very fast style transfer may be achieved (in terms of training steps). Trade-offs include a need to devise a selection procedure for the reference (virtual) batch, and the computational overhead that is caused by propagating the reference batch through the network in each training step.

A second type of replacement for conventional batch/instance normalizations in the present systems and methods is dropping the feature map normalization completely in both generators and discriminators in favor of parameter normalization. As shown in the exemplary architecture of FIG. 8, the feature normalization layer in each of the encoders, decoders, bottleneck blocks, and discriminators can be removed and replaced with a spectral normalization. The parameter normalization may be, for example, bidirectional spectral normalization. The spectral normalization serves to normalize and constrain large variations in values of network parameters during training and thus improve training convergence rate. Spectral normalization is a known technique but has not been used in training of CycleGANs. In this second type of replacement, virtual batch selection does not have to be estimated, which is advantageous.

In some embodiments, to facilitate training, channel and spatial attention may be added to the generator network, as the generator is deeper and harder to train than the discriminator. Spatial attention is a type of attention mechanism that assigns weights to spatial information, to tell the neural network what to focus on. In the present embodiments, spatial attention contributes to preserving the object geometry during translation. Channel attention assigns weights to channels, to tell the neural network what channels to focus on. In this second type of replacement, virtual batch selection does not have to be estimated, which is advantageous. Channel/spatial attention have not been used in CycleGANs in conventional techniques because CycleGANs are typically used on simple images (e.g., a single face or object). The application of CycleGANs to images with many features that must be identified within the image, such as many cells, presents new challenges that have not been encountered in other applications.

The two replacements are not mutually exclusive and can be combined. Accordingly, a third type of replacement for conventional batch/instance normalizations in the present systems and methods is combining virtual batch normalization, bidirectional spectral normalization, and attention in the generator and using a spectrally normalized discriminator.

Another innovation of the present systems and methods is changing the architecture of the generators from the conventional ResNet model to a UNet model. As shown in FIG. 8, any of the generators used in autoencoder mode, 810, as well as in the forward and reverse translation steps of the translation mode, 820, can comprise UNet model architecture. The generators have contracting encoders and expanding decoders with skip connections in between. Each of the encoder and decoder blocks can have spatial-channel attention, as explained above, and each skip connection can be gated through spatial-channel mutual attention between encoder and decoder. As described above, the skipped connections are not drawn in FIG. 8 for simplicity of the block diagram. In some embodiments, the UNet architecture is used because UNets preserve fine detail. The motivation behind this change in architecture is that it was discovered in relation to disclosure that the UNet architecture is much less prone to steganography.

In some embodiments, image to image translation can be multimodal, i.e., there is no unique way of stylizing the image from domain A to look as if it belongs to domain B. In some embodiments, translation between images and image masks is multimodal. In the case of mask to image translation it is not possible to know exactly how the masks would look like if they were recorded as an image. Namely, different types of noise might be present, as well as different variations in staining strengths, etc. The problem might arise if the system starts making mistakes in translation—unimodality will cause it to make the same mistakes all the time. To prevent this, the inherently unimodal CycleGAN can be uniquely changed in the present embodiments to become multimodal by adopting some ideas from multimodal frameworks (multimodal unsupervised image-to-image translation “MUNIT”/diverse image-to-image translation “DRIT” or DRIT++) in a unique way. Multimodality allows the present CycleGAN to generate multiple output images based on a single input image. For example, according to FIG. 8, the head blocks for each of the decoders can be multimodal. The answers can then be post-processed in some way (e.g., averaged) and this can improve the performance since, if present, the mistakes in translation would be different for different generated outputs. Some aspects of multimodal frameworks (MUNIT/UNIT) can also be adopted and integrated in CycleGAN to deal with the problem of mode collapse as the translation between domains is inherently multimodal (e.g., images masks and images). This is addressed by the modifications as described below.

In some embodiments, the methods comprise multimodal machine-learning. Multimodality in CycleGAN is achieved in the present embodiments by modifying the generator in two ways. First, the UNet generators have two bottlenecks, one called content bottleneck and the other called style bottleneck. As shown in FIG. 8 the content bottlenecks are represented as C and the style bottlenecks can be represented as S_{A} and Ss. Content bottlenecks are shared between the generators while the style bottlenecks are not. Content bottlenecks encode the invariant content during translation while style bottlenecks encode the style of the domains and the UNet generators. Secondly, the UNet generators have two interchangeable heads (final modules that generate the output image). One of them is used to generate the image from domain A and the other one is used to generate the image from domain B.

The training procedure is modified by having an autoencoder mode of the generator where the generator learns to reconstruct (not translate) the input image. The autoencoder mode can be illustrated according to the architecture of FIG. 8, 810. The reconstruction loss that supervises this mode is L1 loss. Then there is a translation mode of the generator where two style bottlenecks and two heads are exchanged between the generators, and in this mode the generator translates an image from domain A to domain B in the same way as unimodal CycleGAN. Additionally, the content/style bottlenecks disentangle content and style in an adversarial training with an additional content discriminator (as in DRIT++).

As shown in FIG. 8, the circles indicate where spectral normalization is applied. Regarding spectral normalization, parameters of a deep neural network (a.k.a. weights) are learned by an iterative training procedure on training data, where the goal is to find optimal weights that minimize a loss function (i.e., a difference between the predicted results produced by the deep neural network and the ground truth). In order to improve efficiency of learning the weights, several computational frameworks have been developed in the literature aimed at improving the convergence rate of learning or stabilizing the minimization of loss through iterations. One of such frameworks is spectral normalization of the weights. Spectral normalization differs from feature or batch normalization. Feature and batch normalization may be layers of the model that data is fed into. The feature and/or batch normalization layers, thus, can change the data encodings. In contrast, spectral normalization is performed on the weights and is not a layer of the model.

Spectral normalization (“norm”) was first introduced (T. Myato et al., “Spectral Normalization for Generative Adversarial Networks” available on arxiv.org) as a method of dividing the weights (i.e., normalizing the weights) of a layer of a neural network with the spectral norm of the weight matrix. The method uses spectral normalization in the context of learning a Generative Adversarial Network (GAN), specifically for the discriminator network in a GAN. The main motivation for this was the fact that the gradients of loss for both generator and discriminator in a GAN depend on the discriminator network and that spectral normalization stabilizes their training by setting the upper bound on the Lipschitz constant of the Discriminator.

This method was further advanced (Zinan Lin et al., “Why spectral normalization stabilizes GANs: Analysis and Improvements” available on arxiv.org), where spectral normalization was shown to control both exploding and vanishing gradients of loss in training. In a convolution neural network, the weights of a layer form a tensor with four indices, so there are many ways to form a matrix (a tensor with two indices) from the tensor. The authors showed that there are two relevant matrix reshapes of the weight tensor with different spectral norms in general. They further suggested dividing the weight tensor by the arithmetic mean of these two spectral norms, and showed both theoretically and experimentally that it offers an even better control of the GAN training than ordinary spectral normalization (SN). They call this procedure bidirectional spectral normalization.

In the present systems and methods for image-to-image translation, bidirectional spectral normalization may be used not only in the discriminator but also in the generator. For example, the generators depicted in FIG. 8 comprising domain encoders, bottleneck blocks and domain decoders. An insight for this unique change follows from the need to remove various feature normalizations that are common in practice when training a neural network in order to control vanishing gradients and explosion of gradients of loss. Feature normalizations are less desirable techniques in biomedical images, because they lead to inconsistent modification of biological content (e.g., hallucination of new cells and other objects in image-to-image translation). However, a deep neural network without normalizing layers is very difficult (often impossible) to train and requires very careful parameter initializations as known in the art. Insights involved with the present disclosure include realization of a need to find an alternative to these standard normalization techniques. In the present disclosure, bidirectional spectral normalization was discovered to be a desirable alternative, where the networks are both trainable and image content does not get modified.

An innovation in the present use of bidirectional spectral normalization in a neural network such as a CycleGAN is a numerical efficiency and new technique for computing the normalization factor in spectral normalization. Previous methods known in the art for computing the spectral norm of a weight matrix in neural networks use the power method. This is the default implementation in deep learning frameworks such as PyTorch. In contrast, the present systems and methods offer another, more efficient, deterministic way of estimating the spectral norm by using its tight lower bound. That is, the systems do not compute the exact spectral norm but its lower bound approximation. The approximation approach for computing spectral normalization provides computational efficiency. Experimental results performed in relation to the present disclosure showed that, counterintuitively, such approximation appeared even more suitable for spectral approximation of the weights than the accurate spectral norm, because the lower bound underestimates the spectral norm (rather than overestimates it) which gives slightly better results. The present approach has shown faster initial convergence of the neural network than standard (power method) estimation while remaining stable across different domains.

The approximate bidirectional spectral normalization is carried out on a convolutional layer of a neural network with c input channels, d output channels, and kernel size of kₓ×k_{y} (kₓ×k_{y}×k_{z} in the case of a three dimensional convolution). This layer has a weight tensor w with four indices which can be thought of as a four-dimensional matrix of shape d×c×kₓ×k_{y}. From this tensor two (ordinary two dimensional) matrices A and B are constructed by two unfoldings of w. Matrix A has the shape of d×(c kₓ k_{y}) and matrix B has the shape of c×(d kₓ k_{y}). If d≤c kₓ k_{y} a matrix C=AA^{T} is formed, otherwise C=A^{T}A. C is a positive semidefinite square matrix. If c≤d kₓ k_{y} a matrix D=BB^{T} is formed, otherwise D=B^{T}B. D is a positive semidefinite square matrix.

The formulas below from J. K. Merikoski and R. Kumar “Lower bounds for the spectral norm” (Journal of Inequalities in Pure and Applied Mathematics) is used to estimate the spectral norms of C and D.

In these formulas, quantities cⱼ, dⱼ, r_{c}, r_{d} are respectively j-th column vector of C, j-th column vector of D, row sum vector of C and row sum vector of D. Spectral norms of A and B are then found as square roots:

Finally, the weight tensor is modified by dividing it by the mean of these two spectral norms:

The loss functions utilized in the present disclosure may include the following: 1) mean squared error for adversarial loss; 2) mean squared error for content adversarial loss; 3) mean absolute error for cycle consistency loss; 4) mean absolute error for image reconstruction loss in the autoencoder mode; 5) mean absolute error between the content features of the original and translated image; and/or 6) contrastive loss between the style features of two domains, that pushes them away from each other. The loss functions may be applied as demonstrated in FIG. 8, wherein the discriminators (e.g., 825) use adversarial loss, the translation mode, 820, uses cycle consistency loss and autoencoder mode, 810, uses L1 loss.

An important advantage of the present innovation is test time adaptation; that is, the ability of the system to adapt at the time of use on the desired target images. The present image-to-image translation module does not need to be proficient at generalizing on unseen images that belong to the domain B. This is because the system adapts its translation at test time to all images that are to be translated. This does not mean that the system will not generalize and not perform well on unseen samples. However, if it does not, the system can be retrained or fine-tuned (i.e., adapted in test time) to those samples. In other words, the goal of the image-to-image translation system is to find the optimum on the given samples even at the cost of poor generalizability, which is counterintuitive to standard practices.

Variations on the techniques and structures described herein may be utilized. In one example, other unpaired translation frameworks may be used other than CycleGAN, such as unsupervised image-to-image translation (UNIT), MUNIT, or DRIT. In some embodiments, diffusion models can be used. In some embodiments, the machine learning models described herein may be diffusion models trained with unpaired training images for any of the application described herein, such as but not limited to identifying markers and enhancing images.

Another example variation is that if CycleGAN is the framework of choice, generator and discriminator architectures can be changed in an asymmetrical way. For example, if the complexities of the two domains A and B are very different from each other, then it may make sense to have different generators for two directions (e.g., architecture of G_{AB} according to top half of 820, differing from the architecture of G_{BA}, according to the bottom half of 820) and different discriminators for different domains (e.g., architecture of D_{A} differing from the architecture of D_{B}, according to FIG. 8).

Various loss functions may be used. For example, if CycleGAN is the framework of choice, the losses used may be the mean squared error as adversarial loss and mean absolute error as cycle consistency loss. An optional identity loss may be used as described above. Another example of a loss function that may be used is the “MSSIM+11” loss (Multiscale structural similarity+mean absolute error) as the cycle consistency loss. This loss has been studied in literature as being superior to 11 for high resolution image reconstruction, but it comes at the cost of slower performance and possible instabilities for images with low variance regions. A further example of a loss function that may be used is the half-cycle loss that is defined directly between the input image from domain A and translated image to domain B. It may be desirable to maximize some measure of mutual information between the domains in order to enhance content conservation.

Deep features of combined markers in contexts wherein a single fluorophore is imaged in a single color channel and in separate channel contexts might be entangled and very difficult to interpret. To enhance separation at the level of deep features, learned by the encoders, in some embodiments, additional contrastive loss that pulls together features originating from the same markers, while pushing apart features originating from different markers can be used.

Without paired training images, for both superimposed and separated encoders, the images from the separated domain can be used. In some embodiments, features are extracted from marker 1 (or 2) by the superimposed encoder. An image from the separated domain consisting only of a particular marker is propagated through the superimposed encoder. In some embodiments, features are extracted from marker 1 (or 2) by the separated encoder. An image from the superimposed domain is propagated through the separate channel encoder with the channel corresponding to the second marker set to zero.

For a given anchor image from one marker, and its corresponding encoder feature map, the positive is a mean encoder feature map of other images within that marker i.e. this feature map is pulled to be near some center in the representation space that evolves during training. As for the negative training—mean encoder feature maps (i.e. centers) of the two different markers are pushed apart facilitating separation.

In some embodiments, using the shared bottleneck architecture, the features of the individual markers are treated as equal no matter which encoder extracted them and contrastive loss can jointly be applied.

In some embodiments, the decoders DAB and D_{B}A (e.g., as depicted in 820) can share weights either in some initial layers or, in the extreme case, a single module can play the role of both decoders (i.e., effectively having one decoder in the architecture).

In some embodiments, systems and methods of the present disclosure comprises a discriminator neural network configured to produce an adversarial loss using the translated images and the target images; and the generator neural network comprises a virtual batch normalization or a parameter normalization. In some embodiments, the virtual batch normalization comprises a fixed batch of images that is representative of the data corpus or the dataset. In some embodiments, the parameter normalization uses bidirectional spectral normalization. In some embodiments, the generator neural network comprises the parameter normalization and channel and spatial attention. In some embodiments, the discriminator neural network comprises a second parameter normalization that uses bidirectional spectral normalization. In some embodiments, the generator neural network comprises the virtual batch normalization and channel and spatial attention, and the discriminator neural network comprises a second parameter normalization that uses bidirectional spectral normalization. In some embodiments, the bidirectional spectral normalization in the various examples comprises calculation of a lower bound approximation.

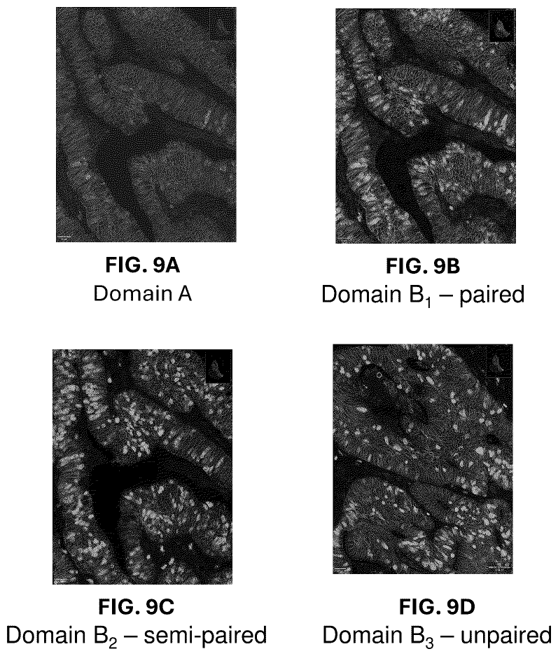

The methods and systems described herein comprise training of 121 translation systems trained with unpaired images. In some embodiment, semi-paired images may be used. Examples of paired, semi-paired, or unpaired images from exemplary domain A and exemplary domain B are illustrated in FIGS. 9A-9D. Domain B in FIGS. 9A-9D can, in general, be divided into three subsets of images—domains B₁, B₂ and B₃. In the paired setting, each image from domain A has a corresponding image in domain B (referred to as subdomain B₁ in FIG. 9B) that shares exactly identical content but differs in style. That is, subdomain (i.e., subset) B₁ as exemplified in FIG. 9B has images that are content-wise paired and aligned with respective images in domain A (FIG. 9A). In the semi-paired setting, each image from domain A is paired with an image in domain B (referred to as subdomain B₂ in FIG. 9C) that contains slightly different—but largely similar—content, while differing in style. In other words, subdomain B₂ includes semi-paired images that share very similar but not identical content with domain A. FIG. 9C illustrates an example of the semi-paired setting where the images of domains A and B show adjacent tissue sections, which exhibit differences in detail but remain similar overall, as they represent the same tissue block. FIG. 9C is an example of a semi-paired image in which the tissue sections is adjacent to the tissue section shown in FIG. 9A. In the unpaired setting, the system is trained on two independent image sets from domain A and domain B (referred to as subdomain B₃ in FIG. 9D), where both content and style may vary significantly. Subdomain B₃ contains images that are entirely unpaired with any image from domain A. In practice, domain B may consist of one, two, or all three of these types of subsets.

In unpaired learning as described herein, the degree of content variation between the two domains—in terms of spatial layouts, sizes, orientation, and shapes of objects—can be large (e.g., patches of different tissue samples from different patients). This degree of content variation is upper-bounded by the constraint that all images from both domains represent similar biological content (e.g., breast or lung tissue). The present 121 training performs well in all settings: (i) when only unpaired domain B images are available for training, (ii) when unpaired as well as some paired or semi-pared images of domain B are available, and/or (iii) full dataset of paired images are available for training. That is, the present 121 training performs well when only unpaired B₃ images are available for training, as it does in other cases where other types of images B₁, B₂ and B₃ are available.

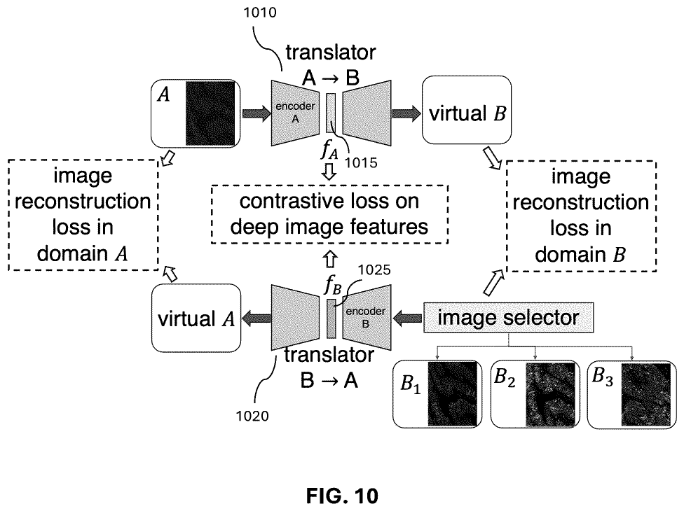

According to some embodiments, the design of the present systems and methods supports simultaneous 121 training on image datasets that include any combination of the three settings (paired, semi-paired, unpaired). As described above, FIGS. 9A-9D illustrate an example in which domain B is divided into three subsets of images—B₁, B₂ and B₃. Subset B₁ contains images that are content-wise paired with respective images in domain A; subset B₂ includes semi-paired images that share very similar but not identical content with domain A—such as, e.g., images of adjacent tissue slices; and subset B₃ has images that are entirely unpaired with any image from domain A. A key innovation of the present training framework lies in the framework's ability to leverage the content-wise similarity between paired and semi-pared images in domains A and B, when available. Specifically, the present systems and methods apply stronger constraints and additional regularization when training on the more content-similar subsets B₁ and B₂ compared to B₃, as illustrated in FIG. 10. This innovative approach guides the i2i model to better align shared content across the two domains and improve translation quality.

FIG. 10 is a block diagram of a training flow, in accordance with some aspects. The 121 training framework leverages the strong content-wise similarity between images in domains A and subdomains B₁ and B₂, if domain B encompasses paired and semi-paired images. The example images in FIG. 10 are identical to those shown in FIGS. 9A-9D. The 121 training applies additional regularization when training on the more content-similar subsets B₁ and B₂ compared to B₃. To train the translation in the direction A-to-B (block 1010), images from domain A are input to the encoder A to extract deep image features f_{A}, which are subsequently passed to the generator 1015 to produce the corresponding virtual image in the style of domain B (“virtual B”). To train the translation in the direction B-to-A (block 1020), images from domain B are input to the encoder B to extract deep image features f_{B}, which are subsequently passed to the generator 1025 to produce the corresponding virtual image in the style of domain A (“virtual A”). In case paired and semi-paired images are available in domain B, the image selector module selects the appropriate image from B₁ and B₂ that exactly corresponds to the input image from domain A (e.g., showing the same or adjacent tissue slice); otherwise, any image is randomly selected from B₃. In addition to the standard cycle consistency loss and adversarial loss used in CycleGAN training, the following loss functions are also accounted for in the 121 training: image reconstruction loss in domain A, image reconstruction loss in domain B, and contrastive loss between the deep image features f_{A} and f_{B}. The reconstruction loss enforces that the generated virtual image is as similar as possible to the input image. The contrastive loss enforces that a distance between the deep features of paired or semi-paired images is smaller than a distance between unpaired images.

As shown in FIG. 10, the 121 bidirectional translation is trained with three additional loss functions, along with the standard cycle consistency loss and adversarial loss used in CycleGAN training (see FIG. 8). In case paired and semi-paired images are available in domain B, the appropriate image from B₁ and B₂ is first selected so that it exactly corresponds to the input image from domain A. Then, 121 generates the corresponding virtual A and virtual B images. As the input images are paired or semi-paired, ideally, the output virtual B image is identical or semi-identical to the input image A. Therefore, in training on paired and semi-pared images, the image reconstruction loss is additionally accounted for in domain A (loss “L_{A}”):

$${L}_{A} = {‖ image A - virtual image A ‖}_{2}$$

and the image reconstruction loss in domain A (loss “L_{B}”):

$${L}_{B} = {‖ image B - virtual image B ‖}_{2}$$

where ∥₂ stands for L-2 norm between pixel values. Other calculations for reconstruction loss may be used, such as LA=|image A−virtual image A1 and LB=|image B−virtual image B₁, where |·| denotes absolute L-1 norm difference between pixel values, or more sophisticated formulations which use learned distances in the projected feature space as:

$${L}_{A} = exp ( - {( {W}_{A} \cdot Vector ( image A ) )}^{T} \cdot ( {W}_{A} \cdot Vector ( virtual image A ) ) ) and$$

$${L}_{B} = exp ( - {( {W}_{B} \cdot Vector ( image B ) )}^{T} \cdot ( {W}_{B} \cdot Vector ( virtual image B ) ) ) ,$$

where matrices W_{A} and W_{B} are learned on training data, and Vector( ) is a function that reshapes the 2D image to the corresponding 1D vector.

Importantly, for semi-paired images in subdomain B₂, deformable image registration is performed between the virtual image A and image A and between the virtual image B and image B prior to computing their reconstruction losses, in order to account for their small but inherent content differences.

Furthermore, in case paired and semi-paired images are available in domain B, the contrastive loss is additionally accounted for, expressed in terms of the deep image features f_{A} and f_{B} estimated by the encoder A and encoder B respectively, as shown in FIG. 10. For every image in domain A, triplets of deep features are formed:

$$( {f}_{A} , {f}_{B}^{+} , \{ {f}_{B}^{-} \} )$$

where

$${f}_{B}^{+}$$

is the “positive” deep feature representing the paired or semi-paired image from B1 or B2 which corresponds to the image A, and

$$\{ {f}_{B}^{-} \}$$

is the set of “negative” deep features of all unpaired images from B3.

Since similarity between the image A and its positive,

$$s ( {f}_{A} , {f}_{B}^{+} ) ,$$

must be greater than similarity between the image A and its negative,

$$s ( {f}_{A} , {f}_{B}^{-} ) ,$$

the 121 training is regularized with the following contrastive loss:

$${L}_{C} = - log \frac{s ( {f}_{A} , {f}_{B}^{+} )}{s ( {f}_{A} , {f}_{B}^{+} ) + {\sum }_{i ∈ {B}_{3}} s ( {f}_{A} , {f}_{B , i}^{-} )}$$

where feature similarity is defined as:

$$s ( {f}_{A} , {f}_{B} ) = exp ( {f}_{A}^{T} \cdot {f}_{B} )$$

where “·” denotes a scalar product between two vectors.

### C. Further Exemplary Applications of Image to Image Translation

As a direct consequence of the innovations, the range of applications that 121 translation can support is significantly expanded—addressing scenarios that existing 121 systems are unable to handle. By selected training data for an intended purpose, the models are easily transferable for multiple applications.

The applications of the 121 translation system described herein include but are not limited the following:
1. Translation from an input real-world image to a single output image:
   a. Image adaptation: translating images to the domain an A1 model was trained on to retain the performance of that model on new data
   b. Stain standardization or normalization
   c. Image resolution enhancement
   d. Image focus enhancement
   e. Virtual image coloring—e.g., for virtual staining of biomedical images.
   f. Estimation of image background or unwanted signal: The system can estimate and then subtract an unwanted signal from an image that contains that unwanted signal superimposed with the signal of interest. To perform this, the system is trained on two unpaired datasets: (a) images that contain the unwanted signal and the signal of interest, and (b) images that contain only the unwanted signal. The images in dataset (b) serve as a “negative control” which enables the system to learn how to estimate unwanted (e.g., background) signals.
2. Translation of an input real-world image to multiple output real-world images:
   a. Unmixing fluorescent markers from a single channel to multiple channels
   b. Chromogenic stain separation of IHC color images into separate images for each color.
3. Translation from an input real-world image to multiple object segmentation masks
   a. Unsupervised segmentation of an input images into object segmentation masks
4. Translation of an artificially generated image to another synthetic image with desired appearance qualities:
   a. More realistic stylization of artificially generated images.

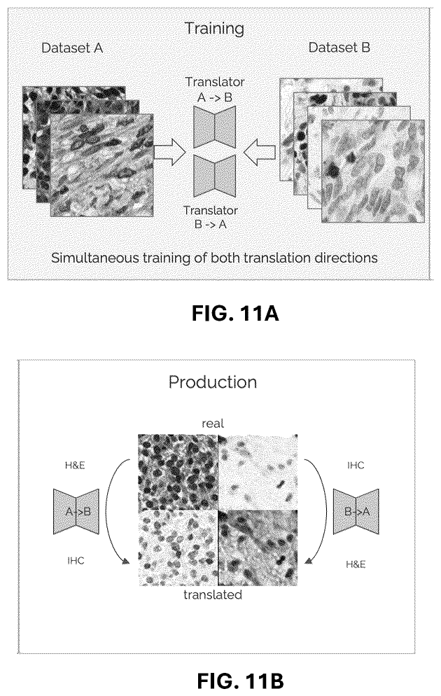

The methods and systems described herein can be used for translating images from different imaging techniques, such as hematoxylin-and-eosin (H&E) and immunohistochemistry (IHC). FIGS. 11A-11B are schematic block diagrams of training and inference regimes of the present image-to-image translation systems and methods, in accordance with some aspects as applied to changing images between H&E and IHC. In FIG. 11A, training of the 121 system involves images that belong to two different domains A and B. In the example of FIG. 11A, dataset A (domain A) is illustrated as hematoxylin-and-eosin (H&E) images, and dataset B (domain B) is illustrated as immunohistochemistry (IHC) images. During training, the 121 system learns bidirectional translation, which transforms images from dataset A to resemble those in domain B, and vice versa—translating images from domain B to appear as if they belong to domain A. In the inference regime (also referred to as production in this disclosure) depicted in FIG. 11B, the 121 system takes images from either domain B or domain A as input and generates corresponding images which resemble the opposite domain. That is, the inference regime takes a new image from domain A or domain B as input, and outputs a corresponding translated image with the style of the opposite domain—B or A, respectively.

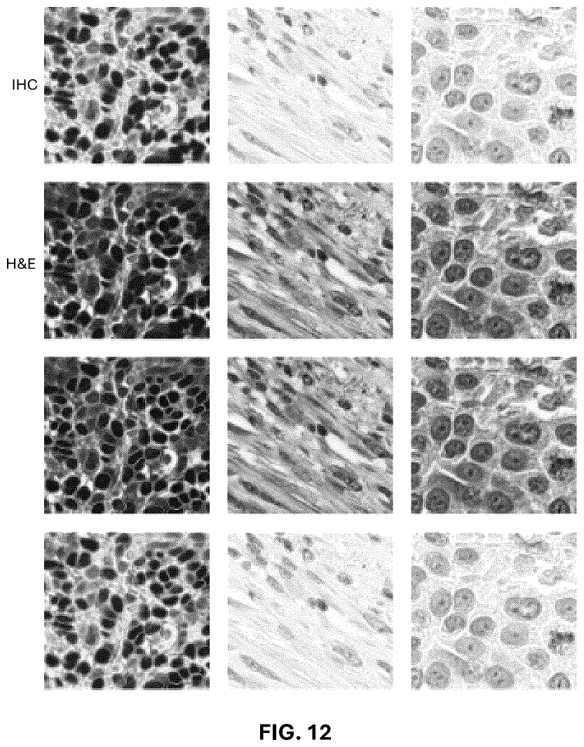

FIG. 12 shows example results of the 121 translation system applied to the task of domain adaptation—specifically, converting immunohistochemistry (IHC) images (first column) to their corresponding hematoxylin-and-eosin (H&E) images (second column). That is, in this example domain A has H&E images, while domain B contains IHC images. The 121 system is trained to convert IHC images to H&E images to enable reuse of an existing model trained on H&E images, where the existing model trained on H&E is successfully used for segmentation (third column). This task belongs to 121 translation applications when an input real-world image is translated to a single output real-world image (fourth row) in which the IHC images are segmented using the H&E segmentation model.

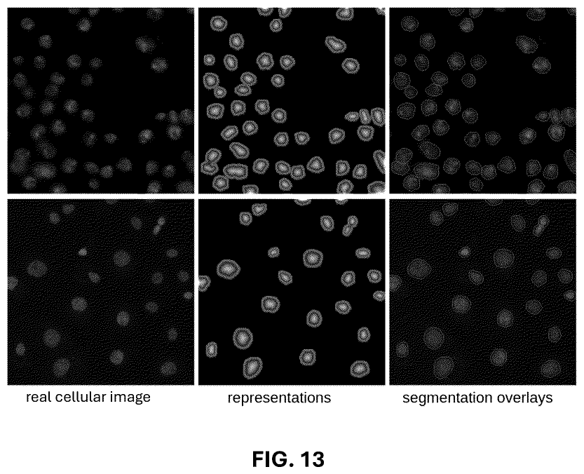

The methods escribed herein can be used for unsupervised nuclear segmentation tasks, where unpaired datasets of the images intended for segmentation and images of mask representations (synthetic or real) are used for training the translation model. FIG. 13 shows results of the present 121 translation system applied to the task of unsupervised nuclear segmentation. The left-hand column labeled “real cellular image” are input immunofluorescent images. The middle column shows corresponding output nuclear segmentation masks (“representations”), and the right-hand column shows segmentation results overlaid onto the input image for better visualization (“segmentation overlays”). This task belongs to the group of 121 translation applications when an input real-world image is translated to an object segmentation mask.

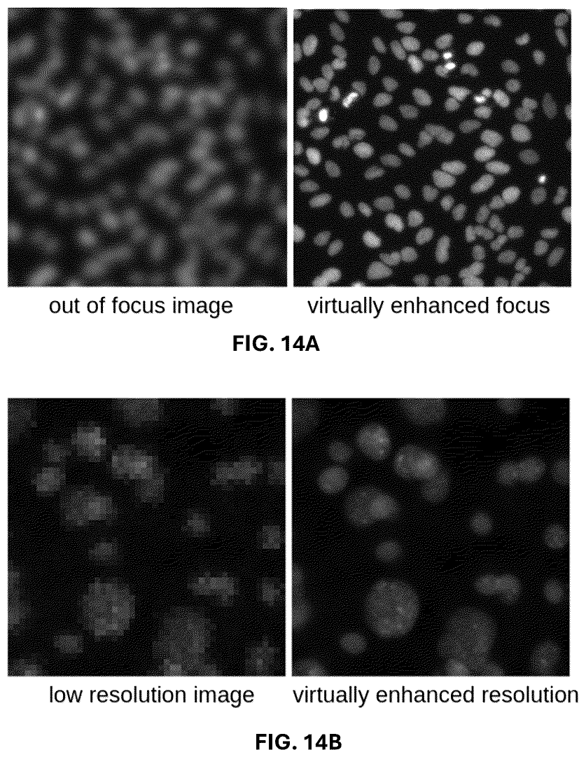

The methods and systems described herein can be used for image enhancement. FIGS. 14A-14B shows results of the 121 translation system applied to the task of image enhancement, where image quality in terms of focus or resolution is enhanced. In training, the first domain contains low-quality images, and the second domain contains images with enhanced (desired) quality. The 121 system effectively learns to enhance the low-quality images by converting them to the style of images in the second domain. FIG. 14A illustrates image focus enhancement, while FIG. 14B illustrates image resolution enhancement. Both FIGS. 14A and 14B demonstrate translation of an input low-quality image (left-hand image) into the corresponding enhanced image (right-hand image). This task belongs to the group of 121 translation applications when an input real-world image is translated to a single output real-world image. Methods known in the art can be used to generate enhanced images, such as the plurality of enhanced images for training the machine learning models described herein. The resolution and sharpness of an image may be changed by, for example, changing the dyes or optimizing dye concentration. In some embodiments, changing the dye concentration may enhance an image based on a changing the signal to noise ratio and thus lowering background and crosstalk signal. In some embodiments, a different microscope channel or different microscope settings may be used to produce an enhanced image. This may be based on the level of autofluorescence and/or crosstalk in different microscope channels or with different microscope settings.

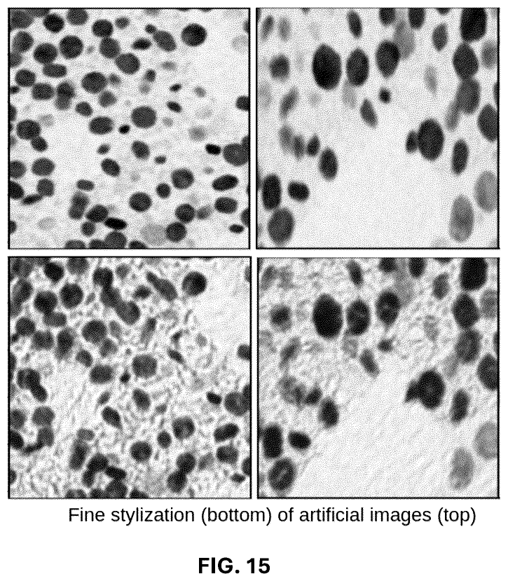

The methods and systems described herein can be used for improving the stylization of artificially generated images. FIG. 15 shows example results of applying the 121 translation to the task of more realistic stylization of artificially generated images. This task is important for robust training of deep neural networks on small datasets which are augmented with artificially generated image examples. The artificial images are typically generated using a generative model trained to generalize well across a multitude of images. However, a general generator trained to perform well in all settings may not produce sufficiently realistic images in a particular setting. In such a case of a particular setting, instead of fine-tuning the generator, the 121 system may be used for realistic stylization of artificially generated images. In training, the first domain has artificially generated images, and the second domain contains real-world images. The 121 system effectively learns to enhance artificial images by converting them to the style of real-world images in the second domain. FIG. 15 demonstrates translation of an input synthetic image (top images) into the corresponding, more realistic image (bottom images). This task belongs to the group of 121 translation applications when an input synthetic image is translated to another synthetic image.

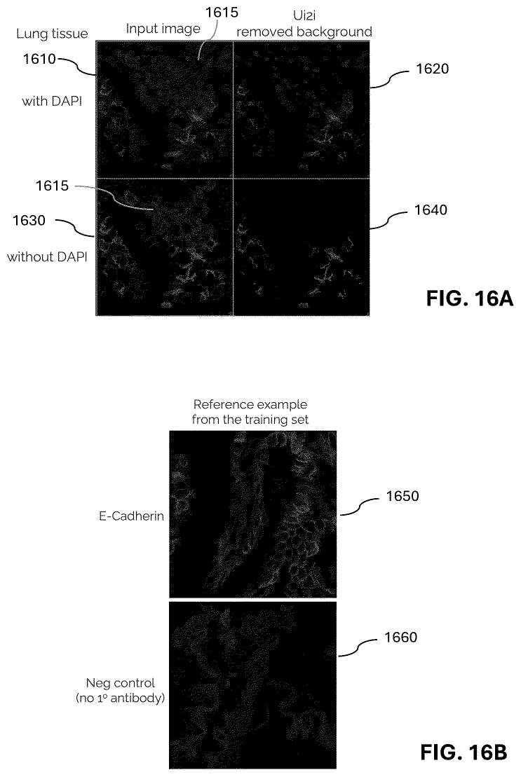

The methods and systems described herein can be used to remove a background signal from a fluorescence image. FIGS. 16A-16B illustrate unpaired image-to-image translation for signal removal, such as removal of a background signal. In this use case, the training framework of the system learns to estimate a background signal or other unwanted signal in fluorescence images from two datasets: (1) full fluorescence panel that the trained system will be used for (2) same panel but with, for example, the primary antibody of interest omitted. This technique may be used, for example, in situations where there is an image and an interfering background that can be shown separately. Taking immunofluorescence (IF) as an example, in IF a primary antibody attaches to the substance of interest (e.g., a marker or protein). A secondary antibody carrying a fluorophore attaches to the primary antibody and exhibits fluorescence, thus identifying the substance of interest. A background signal in a fluorescence image can arise from several sources including sample autofluorescence, non-specific staining, spectral crosstalk, and imaging artifacts. Autofluorescence is fluorescence by the tissue itself. Non-specific staining can occur when the primary or secondary antibodies attach to substances other than the substance of interest. Crosstalk is overlap in signals from different channels (i.e., different frequencies in the image).

The 121 approach described herein uniquely addresses this challenge of removing an unwanted signal by training the model to translate between standard images and negative controls. Negative controls are images that are prepared identically to the standard sample (e.g., both IF-type images), except the signal of interest for that channel is omitted while all other markers and fluorophores (e.g., secondary antibody) in the panel remain unchanged. This ensures the negative control captures only the unwanted background signal. Negative controls are known in conventional techniques, but are used either manually (i.e., visual estimation by humans) or are utilized only to perform simple background (e.g. flat constant) subtraction from the image. In contrast, in the techniques of the present disclosure the system learns how to estimate the unwanted signals from different scenarios and can apply that learning to new scenarios. It is important to note that this estimation must be performed as unpaired or semi-paired translation, in an unpaired or semi-paired mode, because the same biological sample cannot be imaged under both scenarios. In semi-paired mode, sequential tissue sections could be used for each mode, but that severely limits the applicability of this approach. Fully paired examples are impossible to acquire, which makes this approach impossible to perform using models that require paired training data. Once trained, the model (trained framework) can infer the background or unwanted signal from a standard image and subtract it, isolating the clean signal of interest.

FIGS. 16A-16B show example immunofluorescence images of lung tissue in which a background signal is removed. In FIG. 16A, image 1610 is an input image exhibiting IF signals and DAPI staining (4′,6-diamidino-2-phenylindole for staining cell nuclei). Image 1620 is the image 1610 but with background signal 1615 removed using the unpaired image-to-image translation of the present disclosure. Image 1630 is the same IF image shown without DAPI, where background signal 1615 can be seen more clearly than in image 1210. Image 1640 is the same as the image 1620, but shown without DAPI for easier appreciation of the quality of the background removal.

FIG. 16B shows an example training set for training the model to estimate background or unwanted signals. Image 1650 is an IF image identifying E-Cadherin protein in cellular tissue. Image 1650 serves as a standard image of the unpaired training set. Image 1660 is a negative control in which the primary antibody for E-Cadherin is omitted, and only the background signal appears. The systems and methods of the present disclosure can use these types of unpaired images of FIG. 16B to estimate background or other unwanted signals and to use that learning to infer to unwanted signals as demonstrated in FIG. 16A.

The removal of an unwanted signal as described regarding FIGS. 16A-16B may be implemented by the CycleGAN or another framework described herein. Regardless of the framework for unpaired image-to-image translation that may be utilized (e.g., CycleGAN or alternative AI framework), the core inventive principle remains the same: learning a transformation between images containing superimposed signals and images in which those signals are separated. This approach is essential for enabling accurate signal separation. Likewise, the foundational method for high-quality background removal as described herein involves learning a transformation from unpaired images containing both the signal of interest and unwanted signal, to images representing only the unwanted signal. Once trained, the system can estimate the background component in a real experimental image, which can then be subtracted to isolate the true signal of interest.

Multiple trained 121 translation models as described herein can be combined for a full workflow. For example, channel separation can be an initial task performed by a trained 121 translation model and a downstream task such as background removal can be performed by a second trained 121 translation model. It is also contemplated that the downstream tasks such as nuclei and membrane segmentation, cell classification, etc. can also be applied using known methods. For example, the channel separated image may be run through the trained 121 translation model to separate the channels and then cells can be classified based on separated channels with some other model/algorithm. The two stages (demultiplexing and a downstream task) can be converted into one by knowledge distillation techniques.

### D. Imaging Techniques

The methods and systems described herein can be used for image to image translation of fluorescence images. In some embodiments, the images are 2D. In some embodiments, the images are 3D. One skilled in the art would recognize that alternative methods for fluorescently labeling a sample for imaging can be applied and the resulting methods and system would remain functional. A variety of markers can be used for fluorescent labeling as described herein. Non-limiting examples of alternative methods for fluorescently labelling a sample for imaging comprise fluorescent dyes, genetically encoded fluorescent proteins (e.g., GFP, mCherry), fluorescent ligands or drugs, nucleic acid probes, labelled virus probes quantum dots, click chemistry labeling, and vital dyes/functional indicators.

In some embodiments, fluorescent signals may be introduced into biological samples through endogenous or exogenous means. Endogenous sources include autofluorescence arising from native biomolecules such as NADH, FAD, or structural proteins. Exogenous sources may include, without limitation, small-molecule fluorescent dyes, environment-sensitive probes, ion-sensitive probes, and immunofluorescence methods wherein fluorophores are conjugated directly or indirectly to antibodies. In further embodiments, fluorescent signals may be generated through genetically encoded systems, including but not limited to fluorescent proteins, fluorescent protein fusions, biosensors, self-labeling enzyme or peptide tags (e.g., HaloTag, SNAP-tag, CLIP-tag), or split-fluorescent protein complementation systems. Additional embodiments may employ nucleic acid-based strategies, such as fluorescent in situ hybridization (FISH), molecular beacon probes, or RNA aptamer-fluorophore complexes, as well as promoter-driven reporter constructs. In yet other embodiments, fluorescent signals may be provided by nanoparticles, including but not limited to quantum dots or fluorescent beads, or through chemical or metabolic labeling strategies, including click chemistry and incorporation of fluorescent precursors. Fluorescent ligands or drugs conjugated to fluorophores for monitoring binding interactions may also be employed. Accordingly, the present disclosure encompasses image processing of samples labeled by any of the foregoing methods, either alone or in combination.

Fluorescent Dyes (e.g., DAPI, phalloidin) are small-molecule dyes that bind directly to cellular structures such as DNA (DAPI) or actin (phalloidin), without requiring antibodies. In some embodiments, the fluorescent dyes comprise environment-sensitive proves such as but not limited to lipid dyes like Nile Red, polarity-sensitive dyes like Laurdan. In some embodiments, the fluorescent dyes comprise Ion indicators such as but not limited to Fluo-4 for Ca² and Fura-2, BCECF for pH. Single-channel marker merging uses custom-labeled dyes targeting different structures but conjugated to the same fluorophore to combine signals in a single channel. A channel-specific negative control omits the dye used in the tested channel, keeping all other dyes and protocol steps the same. This reveals autofluorescence and bleed-through from nearby channels. The methods and systems described herein can be used to identify markers and enhance images generated in this manner.

Genetically encoded fluorescent proteins (e.g., GFP, mCherry) can be used to fluorescently label a sample for imaging. In this technique, cells or organisms are genetically engineered to express fluorescent proteins, either constitutively or fused to specific proteins of interest. In some embodiments, genetically encoded fluorescent proteins comprise are marked using stably integration of GFP, RFP, mCherry, etc, fusion proteins: (e.g., fluorescent tag fused to protein of interest for localization and dynamics), and/or using biosensors (e.g., genetically encoded FRET-based or single-fluorophore sensors for ions, metabolites, or signaling event). Reporter constructs can also be used wherein promoter and or signaling pathway molecules drive fluorophore expression. Single-channel marker merging involves multiple fluorescent protein-tagged constructs that emit in the same spectral range (e.g., multiple GFP fusions), resulting in a combined signal in one channel. A channel-specific negative control uses a non-transfected or wild-type sample that lacks the fluorescent protein, processed and imaged identically. This negative control detects autofluorescence and spectral leakage from other fluorophores. The methods and systems described herein can be used to identify markers and enhance images generated in this manner.

Fluorescent protein and/or peptide tags can also be used. In some embodiments, fluorescent protein and/or peptide tags comprise epitope tags, self-labeling enzyme tags, and/or split-FP complementation.

Fluorescent ligands or drugs can be used to fluorescently label a sample for imaging In this technique, fluorophore-conjugated small molecules bind selectively to biological targets such as receptors, enzymes, or lipids. In a non-limiting example, fluorescent EGF is to track receptor binding. Single-channel marker merging applies multiple fluorophore-labeled ligands in parallel, each binding different targets but tagged with the same fluorophore. A channel-specific negative control is created by including an excess of unlabeled ligand to block binding of the labeled version for the tested channel. This identifies off-target binding, crosstalk, and non-specific uptake. The methods and systems described herein can be used to identify markers and enhance images generated in this manner.

Fluorescence In Situ Hybridization (FISH) can be used to fluorescently label a sample for imaging. In FISH, fluorescently labeled nucleic acid probes hybridize to complementary DNA or RNA sequences in fixed samples. FISH are built based on the updated neural network template In some embodiments, other labeled nucleic acids include molecular beacons (or other hybridization-based fluorogenic oligos) and/or RNA adaptomers (e.g., Spinach, Mango) binding small fluorescent molecules. The methods and systems described herein can be used to identify markers and enhance images generated in this manner.

Quantum dots and fluorescent beads/nanodots can be used to fluorescently label a sample for imaging. Quantum dots are bright, photostable nanoparticles with narrow emission spectra, typically conjugated to targeting molecules like antibodies or ligands. Nanodots can be used for tracking, multiplexing and calibration. Single-channel marker merging involves conjugating different targeting molecules to the same quantum dot and applying them simultaneously. Their signals will overlap in the shared detection channel. A channel-specific negative control excludes the targeting molecule for the tested quantum dot while keeping others. This identifies non-specific dot accumulation, aggregation artifacts, and spectral overlap. The methods and systems described herein can be used to identify markers and enhance images generated in this manner.

Click Chemistry Labeling can be used to fluorescently label a sample for imaging. The method may involve biooorthogonal chemical reactions such as azide-alkyne cycloaddition enable covalent attachment of fluorescent tags to specific biomolecules in living or fixed cells. Single-channel marker merging uses different reactive precursors (e.g., sugar, lipid, or protein analogs) that are all labeled with the same fluorophore via click chemistry, resulting in a merged signal. A channel-specific negative control omits one of the reaction partners (e.g., azide or alkyne) for the tested channel, keeping the rest of the panel unchanged. This reveals background from unreacted dye or non-specific labeling. The methods and systems described herein can be used to identify markers and enhance images generated in this manner.

Vital Dyes/Functional Indicators can be used to fluorescently label a sample for imaging. Vital dyes utilize fluorescent dyes that report dynamic physiological states such as calcium levels, membrane potential, or intracellular pH. In single-channel marker merging, multiple dyes with overlapping emission spectra (e.g., calcium and pH indicators) are loaded to obtain composite functional information in a shared channel. A channel-specific negative control uses cells lacking the physiological parameter of interest (e.g., calcium-free buffer for calcium indicators) or omits the dye. This establishes baseline fluorescence and filters out artifactual responses. The methods and systems described herein can be used to identify markers and enhance images generated in this manner.

Metabolic labeling with Fluorescent precursors can be used to fluorescently label a sample for imaging. In this technique, cells incorporate fluorescent analogs of metabolites like glucose, amino acids, or lipids during active metabolic processes. Single-channel marker merging involves applying multiple metabolite analogs tagged with the same fluorophore to visualize total metabolic incorporation in one channel. A channel-specific negative control uses cells that are not exposed to the fluorescent precursor, or blocks uptake with a competitive inhibitor. This reveals background from autofluorescence and non-specific metabolite retention. The methods and systems described herein can be used to identify markers and enhance images generated in this manner.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

### EMBODIMENTS

Non-limiting aspects of the disclosure are described in the following embodiments.

Embodiment 1. A system for training an image-to-image translation model for immunofluorescence images, the system comprising:
a data corpus having a first dataset of images of immunofluorescence staining, wherein the first dataset of images are demultiplexed;
a dataset having target images with immunofluorescence staining, wherein the target images are multiplexed; and
a training procedure designed to train a generator neural network with the data corpus and the dataset to translate the target images into corresponding translated images that are demultiplexed;
wherein the generator neural network preserves an object geometry of the target images in the translated images and, after being trained, the generator neural network is an image-to-image translation model.

Embodiment 2. The system of embodiment 1, wherein the training procedure is performed using a multi-modal Cycle Generative Adversarial Network (CycleGAN).

Embodiment 3. The system of embodiment 2, wherein:
the generator neural network comprises a style bottleneck and a content bottleneck; and
the CycleGAN comprises a second generator neural network that has a second style bottleneck and is absent of content bottlenecks.

Embodiment 4. The system of embodiment 1, further comprising a discriminator neural network configured to produce an adversarial loss using the translated images and the target images; and
wherein the generator neural network comprises a virtual batch normalization or a parameter normalization.

Embodiment 5. The system of embodiment 4, wherein the virtual batch normalization comprises a fixed batch of images that is representative of the data corpus or the dataset.

Embodiment 6. The system of embodiment 4, wherein the parameter normalization uses bidirectional spectral normalization.

Embodiment 7. The system of embodiment 4, wherein the generator neural network comprises the parameter normalization and channel and spatial attention.

Embodiment 8. The system of embodiment 4, wherein the discriminator neural network comprises a second parameter normalization that uses bidirectional spectral normalization.

Embodiment 9. The system of embodiment 4, wherein the generator neural network comprises the virtual batch normalization and channel and spatial attention, and the discriminator neural network comprises a second parameter normalization that uses bidirectional spectral normalization.

Embodiment 10. The system of embodiments 6, 8 or 9, wherein the bidirectional spectral normalization comprises calculation of a lower bound approximation.

Embodiment 11. A system for demultiplexing immunofluorescence images, the system comprising:
an image-to-image translation model that is trained to translate multiplexed target images into translated images that are demultiplexed, while preserving an object geometry of the multiplexed target images.

Embodiment 12. A method for translating an immunofluorescence image, the method comprising:
providing a data corpus having a first dataset of images of immunofluorescence staining, wherein the first dataset of images are demultiplexed;
inputting target images from a dataset, the target images being of immunofluorescence staining and being multiplexed; and
training, using a training procedure, a generator neural network to translate the target images into corresponding translated images that are demultiplexed, while preserving an object geometry of the target images;
wherein the generator neural network, after the training, is an image-to-image translation model.

Embodiment 13. A system for image-to-image translation, the system comprising: a first domain having first images in a first style; a second domain having second images in a second style, the second domain comprising a first subdomain with a first subdomain style and a second subdomain with a second subdomain style, the first subdomain style being more similar to the first style of the first domain than the second subdomain style is to the first style; and a training framework designed to train a generator neural network to perform bidirectional translation of the first images into the second style and the second images into the first style; wherein the generator neural network preserves image content and object geometry during the bidirectional translation by distinguishing the image content and the object geometry from style features.

Embodiment 14. The system of embodiment 13, wherein the second images comprise at least two of: paired images, semi-paired images, or unpaired images with the first images.

Embodiment 15. The system of any one of embodiments 13-14, wherein the training framework comprises an image selector module configured to select paired images or semi-paired images from the second domain that correspond to the first domain.

Embodiment 16. The system of any one of embodiments 13-15, wherein the training framework comprises an image reconstruction loss for the first domain and for the second domain, and a contrastive loss between deep image features of the first domain and the second domain.

Embodiment 17. The system of any one of embodiments 13-16, wherein the generator neural network comprises a virtual batch normalization.

Embodiment 18. The system of any one of embodiments 13-17, wherein the generator neural network comprises a parameter normalization involving bidirectional spectral normalization.

Embodiment 19. The system of embodiment 18, wherein the generator neural network comprises channel and spatial attention.

Embodiment 20. The system of any one of clauses 13-19, wherein the first images contain an unwanted signal and a signal of interest; the second images contain only the unwanted signal, the second images being unpaired or semi-paired with the first images; and the training framework is trained on the first images and the second images to estimate the unwanted signal from an image.

Embodiment 21. The system of any one of embodiments 13-20, wherein the first images contain multiple merged signals of interest; the second images containing each signal of interest separately imaged in a separate channel, the second images being unpaired or semi-paired with the first images; and the training framework is trained on the first images and the second images to separate merged signals from an image in which those signals are merged in the same channel.

Embodiment 22. A method for digitally identifying markers for a fluorescence image depicting a plurality of markers, comprising:
receiving the fluorescence image, wherein the plurality of markers are represented in a single color channel from a single fluorophore; and
identifying the plurality of markers in the fluorescence image by inputting the fluorescence image into a trained machine-learning model,
   wherein the trained machine-learning model is trained with a plurality of training single-channel fluorescence images and a plurality of training marker-separated fluorescence images, and
   wherein the plurality of training single-channel fluorescence images and the plurality of training marker-separated fluorescence images are unpaired.

Embodiment 23. The method of embodiment 22, wherein identifying the plurality of markers in the fluorescence image comprises displaying a marker-separated fluorescence image depicting the plurality of markers in a plurality of colors.

Embodiment 24. The method of embodiment 22 or 23, wherein the plurality of markers is a first plurality of markers, and wherein the fluorescence image depicts a second plurality of markers represented in a second color channel from a second fluorophore, distinct from the single fluorophore.

Embodiment 25. The method of any of embodiments 22-24, wherein the plurality of training marker-separated fluorescence images depicts each marker in the plurality of markers in a respective color channel.

Embodiment 26. The method of any of embodiments 23-25, wherein in the marker-separated fluorescence image depicts a first marker of the plurality of markers in a first color channel and a second marker of the plurality of markers in a second color channel.

Embodiment 27. The method of any of embodiments 22-26, wherein the plurality of markers each indicates a structural or functional element of a sample depicted in the fluorescence image.

Embodiment 28. The method of embodiment 27, wherein the sample is a biological specimen.

Embodiment 29. The method of embodiment 28, wherein the biological specimen comprises tissues and/or cells.

Embodiment 30. The method of any of embodiments 22-29, wherein the trained machine-learning model comprises a modified cycle Generative Adversarial Network (CycleGAN).

Embodiment 31. The method of embodiment 30, wherein the modified CycleGAN is trained in one or more autoencoder modes and a translation mode.

Embodiment 32. The method embodiment 31, wherein the one or more autoencoder modes are trained based on an L1 loss function.

Embodiment 33. The method of embodiment 31 or embodiment 11, wherein the modified CycleGAN comprises a generator model in a forward direction, a generator models in a reverse direction, and one or more discriminator models

Embodiment 34. The method of embodiment 33, wherein training in the translation mode is based on one or more cycle consistency loss functions based on inputs for the forward direction and outputs from the reverse direction.

Embodiment 35. The method of embodiment 33 or 34, wherein the generator model in the forward direction and/or the generator model in the reverse direction is a UNet generator.

Embodiment 36. The method of embodiment 35, wherein the UNet generator comprises an encoder, a plurality of bottleneck blocks, and a decoder.

Embodiment 37. The method of any of embodiments 33-36, wherein the generator model in the forward direction shares weights at one or more bottleneck blocks with the generator model in the reverse direction.

Embodiment 38. The method of any of embodiment 36 or 37, wherein at least one of the encoder, the plurality of bottleneck blocks, the decoder, and the one or more discriminators comprises one or more layers, and spectral normalization is used in training the one or more layers.

Embodiment 39. The method of embodiment 38, wherein spectral normalization comprises computing a lower bound approximation.

Embodiment 40. The method of any of embodiments 33-39, wherein the one or more discriminators are trained based on an adversarial loss function.

Embodiment 41. A method for enhancing a fluorescence image depicting a one or more markers and a background signal, comprising:
identifying the background signal by inputting the fluorescence image into a trained machine-learning model,
   wherein the trained machine-learning model is trained with a plurality of training positive fluorescence images depicting the one or more markers and fluorescence background signal and a plurality of training negative fluorescence images depicting fluorescence background without the one or more markers, and
   wherein the plurality of training positive fluorescence images and the plurality of training negative fluorescence images are unpaired; and
enhancing the fluorescence image by removing the identified background signal form the fluorescence image.

Embodiment 42. The method of embodiment 41, wherein generating the enhanced fluorescence image comprises: obtaining an output background signal from the trained machine-learning model.

Embodiment 43. The method of embodiment 41 or 42, wherein the one or more marker each indicate a structural or functional element of a sample depicted in the fluorescence image.

Embodiment 44. The method of embodiment 43, wherein the sample is a biological specimen.

Embodiment 45. The method of embodiment 44, wherein the biological specimen comprises tissues and/or cells.

Embodiment 46. The method of any of embodiments 41-45, wherein the trained machine-learning model comprises a modified cycle Generative Adversarial Network (CycleGAN).

Embodiment 47. The method of embodiment 46, wherein the modified CycleGAN is trained in one or more autoencoder modes and a translation mode.

Embodiment 48. The method embodiment 47, wherein training in the one or more autoencoder modes is based on an L1 loss function.

Embodiment 49. The method of embodiment 47 or embodiment 48, wherein the modified CycleGAN comprises a generator model in a forward direction, a generator models in a reverse direction, and one or more discriminator models.

Embodiment 50. The method of embodiment 49, wherein training in the translation mode is based on one or more cycle consistency loss functions based on inputs for the forward direction and outputs from the reverse direction.

Embodiment 51. The method of embodiment 49 or 50, wherein the generator model in the forward direction and/or the generator model in the reverse direction is a UNet generator.

Embodiment 52. The method of embodiment 51, wherein the UNet generator comprises an encoder, a plurality of bottleneck blocks, and a decoder.

Embodiment 53. The method of any of embodiments 49-52, wherein the generator model in the forward direction shares weights at one or more bottleneck blocks with the generator model in the reverse direction.

Embodiment 54. The method of any of embodiment 52 or 53, wherein at least one of the encoder, the plurality of bottleneck blocks, the decoder, and the one or more discriminators comprises one or more layers, and spectral normalization is used in training the one or more layers.

Embodiment 55. The method of embodiment 54, wherein spectral normalization comprises computing a lower bound approximation.

Embodiment 56. The method of any of embodiments 49-55, wherein the one or more discriminators are trained based on an adversarial loss function.

Embodiment 57. A method for enhancing a fluorescence image depicting one or more markers, comprising:
receiving the fluorescence image; and
generating an enhanced fluorescence image by inputting the fluorescence image into a trained machine-learning model,
   wherein the machine-learning model is trained using a training dataset comprising a plurality of enhanced training fluorescence images depicting the one or more markers and a plurality of unenhanced training fluorescence images depicting the one or more markers,
   wherein the plurality of enhanced training fluorescence images and the plurality of unenhanced training fluorescence images are unpaired.

Embodiment 58. The method of embodiment 57, wherein generating the enhanced fluorescence image comprises: obtaining an output fluorescence image from the trained machine-learning model.

Embodiment 59. The method of any of embodiments 57-58, wherein the plurality of enhanced training fluorescence images have a first resolution and the plurality of unenhanced training fluorescence images have a second resolution, wherein the second resolution is higher than the first resolution.

Embodiment 60. The method any of embodiments 57-58, wherein the plurality of enhanced training fluorescence images have a first sharpness and the plurality of unenhanced training fluorescence images have a second sharpness, wherein the second sharpness is higher than the first sharpness.

Embodiment 61. The method of any of embodiments 57-60, wherein the plurality of enhanced training fluorescence images and the plurality of unenhanced training images have been obtained with:
(i) a first set of reagents and a second set of reagents, respectively;
(ii) a first concentration of reagents and a second concentration of reagents, respectively;
(iii) a first microscope and a second microscope, respectively;
(iv) a first plurality of microscopy settings and a second plurality of microscopy settings, respectively; or
(v) a first microscopy channel and a second microscopy channel, respectively.

Embodiment 62. The method of any of embodiments 57-61, wherein the one or more marker each indicate a structural or functional element of a sample depicted in the fluorescence image.

Embodiment 63. The method of embodiment 62, wherein the sample is a biological specimen.

Embodiment 64. The method of embodiment 63, wherein the biological specimen comprises tissues and/or cells.

Embodiment 65. The method of any of embodiments 57-64, wherein the trained machine-learning model comprises a modified cycle Generative Adversarial Network (CycleGAN).

Embodiment 66. The method of embodiment 65, wherein the modified CycleGAN is trained in one or more autoencoder modes and a translation mode.

Embodiment 67. The method embodiment 66, wherein training in the one or more autoencoder modes is based on minimizing an L1 loss function.

Embodiment 68. The method of embodiment 66 or embodiment 67, wherein the modified CycleGAN comprises a generator model in a forward direction, a generator models in a reverse direction, and one or more discriminator models.

Embodiment 69. The method of embodiment 68, wherein training in the translation mode is based on one or more cycle consistency loss functions based on inputs for the forward direction and outputs from the reverse direction.

Embodiment 70. The method of embodiment 68 or 69, wherein the generator model in the forward direction and/or the generator model in the reverse direction is a UNet generator.

Embodiment 71. The method of embodiment 70, wherein the UNet generator comprises an encoder, a plurality of bottleneck blocks, and a decoder.

Embodiment 72. The method of any of embodiments 68-71, wherein the generator model in the forward direction shares weights at one or more bottleneck blocks with the generator model in the reverse direction.

Embodiment 73. The method of any of embodiments 71 or 72, wherein at least one of the encoder, the plurality of bottleneck blocks, the decoder, and the one or more discriminators comprises one or more layers, and spectral normalization is used in training the one or more layers.

Embodiment 74. The method of embodiment 73, wherein spectral normalization comprises computing a lower bound approximation.

Embodiment 75. The method of any of embodiments 68-74, wherein the one or more discriminators are trained based on an adversarial loss function.

Embodiment 76. A method of training a machine-learning model, the method comprising:
obtaining a training dataset comprising a plurality of training single-channel fluorescence images and a plurality of training marker-separated fluorescence images, wherein the plurality of training single-channel fluorescence images and the plurality of training marker-separated fluorescence images are unpaired; and
training, based on the training data, the machine learning model configured to receive an fluorescence image depicting a plurality of markers represented in a single color channel from a single fluorophore and output a marker-separated fluorescence image, depicting each marker in the plurality of markers in a respective color channel.

Embodiment 77. The method of embodiment 76, wherein the machine-learning model comprises a modified cycle Generative Adversarial Network (CycleGAN).

Embodiment 78. The method of embodiment 77, wherein training the modified CycleGAN comprising training in one or more autoencoder modes and a translation mode.

Embodiment 79. The method embodiment 78, wherein training in the one or more autoencoder modes is based on an L1 loss function.

Embodiment 80. The method of embodiment 78 or embodiment 79, wherein the modified CycleGAN comprises a generator model in a forward direction, a generator models in a reverse direction, and one or more discriminator models.

Embodiment 81. The method of embodiment 80, wherein training in the translation mode is based on one or more cycle consistency loss functions based on inputs for the forward direction and outputs from the reverse direction.

Embodiment 82. The method of embodiment 80 or 81, wherein the generator model in the forward direction and/or the generator model in the reverse direction is a UNet generator.

Embodiment 83. The method of embodiment 82, wherein the UNet generator comprises an encoder, a plurality of bottleneck blocks, and a decoder.

Embodiment 84. The method of any of embodiments 80-83, wherein the generator model in the forward direction shares weights at one or more bottleneck blocks with the generator model in the reverse direction.

Embodiment 85. The method of any of embodiment 83 or 84, wherein at least one of the encoder, the plurality of bottleneck blocks, the decoder, and the one or more discriminators comprises one or more layers, and spectral normalization is used in training the one or more layers.

Embodiment 86. The method of embodiment 85, wherein spectral normalization comprises computing a lower bound approximation.

Embodiment 87. The method of any of embodiments 80-86, wherein training the one or more discriminators is based on an adversarial loss function.

Embodiment 88. A method of training a machine-learning model, the method comprising:
obtaining a training dataset comprising a plurality of training positive fluorescence images depicting one or more markers and fluorescence background signal and a plurality of training negative fluorescence images depicting fluorescence background without the one or more markers,
   wherein the plurality of training positive fluorescence images and the plurality of training negative fluorescence images are unpaired; and
training, based on the training data, the machine learning model configured to receive a fluorescence image depicting the one or more markers and a background signal and identify the background signal.

Embodiment 89. The method of embodiment 88, wherein the machine-learning model comprises a modified cycle Generative Adversarial Network (CycleGAN).

Embodiment 90. The method of embodiment 89, wherein training the modified CycleGAN comprising training in one or more autoencoder modes and a translation mode.

Embodiment 91. The method embodiment 90, wherein training in the one or more autoencoder modes is based on an L1 loss function.

Embodiment 92. The method of embodiment 90 or embodiment 91, wherein the modified CycleGAN comprises a generator model in a forward direction, a generator models in a reverse direction, and one or more discriminator models.

Embodiment 93. The method of embodiment 92, wherein training in the translation mode is based on one or more cycle consistency loss functions based on inputs for the forward direction and outputs from the reverse direction.

Embodiment 94. The method of embodiment 92 or 93, wherein the generator model in the forward direction and/or the generator model in the reverse direction is a UNet generator.

Embodiment 95. The method of embodiment 94, wherein the UNet generator comprises an encoder, a plurality of bottleneck blocks, and a decoder.

Embodiment 96. The method of any of embodiments 92-95, wherein the generator model in the forward direction shares weights at one or more bottleneck blocks with the generator model in the reverse direction.

Embodiment 97. The method of any of embodiments 95 or 96, wherein at least one of the encoder, the plurality of bottleneck blocks, the decoder, and the one or more discriminators comprises one or more layers, and spectral normalization is used in training the one or more layers.

Embodiment 98. The method of embodiments 97, wherein spectral normalization comprises computing a lower bound approximation.

Embodiment 99. The method of any of embodiments 92-98, wherein training the one or more discriminators is based on an adversarial loss function.

Embodiment 100. A method of training a machine-learning model, the method comprising:
obtaining a training dataset comprising a plurality of enhanced training fluorescence images depicting one or more markers and a plurality of unenhanced training fluorescence images depicting the one or more markers,
   wherein the plurality of enhanced training fluorescence images and the plurality of unenhanced training fluorescence images are unpaired; and
training, based on the training data, the machine learning model configured to receive a fluorescence image depicting the one or more markers and output an enhanced fluorescence image.

Embodiment 101. The method of embodiment 100, wherein the machine-learning model comprises a modified cycle Generative Adversarial Network (CycleGAN).

Embodiment 102. The method of embodiment 101, wherein training the modified CycleGAN comprising training in one or more autoencoder modes and a translation mode.

Embodiment 103. The method embodiment 102, wherein training in the one or more autoencoder modes is based on an L1 loss function.

Embodiment 104. The method of embodiment 102 or embodiment 103, wherein the modified CycleGAN comprises a generator model in a forward direction, a generator models in a reverse direction, and one or more discriminator models.

Embodiment 105. The method of embodiment 104, wherein training in the translation mode is based on one or more cycle consistency loss functions based on inputs for the forward direction and outputs from the reverse direction.

Embodiment 106. The method of embodiment 104 or 105, wherein the generator model in the forward direction and/or the generator model in the reverse direction is a UNet generator.

Embodiment 107. The method of embodiment 106, wherein the UNet generator comprises an encoder, a plurality of bottleneck blocks, and a decoder.

Embodiment 108. The method of any of embodiments 104-107, wherein the generator model in the forward direction shares weights at one or more bottleneck blocks with the generator model in the reverse direction.

Embodiment 109. The method of any of embodiment 107 or 108, wherein at least one of the encoder, the plurality of bottleneck blocks, the decoder, and the one or more discriminators comprises one or more layers, and spectral normalization is used in training the one or more layers.

Embodiment 110. The method of embodiment 109, wherein spectral normalization comprises computing a lower bound approximation.

Embodiment 111. The method of any of embodiments 104-110, wherein training the one or more discriminators is based on an adversarial loss function.

Embodiment 112. A system comprising:
one or more processors; and
a non-transitory memory coupled to the one or more processors comprising instructions that, when executed by the one or more processors, cause the one or more processors to perform the steps of any one of embodiments 22-111.

Embodiment 113. A system for digitally identifying markers for a fluorescence image depicting a plurality of markers, comprising:
one or more processors; and
a non-transitory memory coupled to the one or more processors comprising instructions that, when executed by the one or more processors, cause the one or more processors to
   receive the fluorescence image, wherein the plurality of markers are represented in a single color channel from a single fluorophore; and
   identify the plurality of markers in the fluorescence image by inputting the fluorescence image into a trained machine-learning model,
      wherein the trained machine-learning model is trained with a plurality of training single-channel fluorescence images and a plurality of training marker-separated fluorescence images, and
      wherein the plurality of training single-channel fluorescence images and the plurality of training marker-separated fluorescence images are unpaired.

Embodiment 114. The system of embodiment 113, wherein identifying the plurality of markers in the fluorescence image comprises displaying a marker-separated fluorescence image depicting the plurality of markers in a plurality of colors.

Embodiment 115. The system of embodiment 113 or 114, wherein the plurality of markers is a first plurality of markers, and wherein the fluorescence image depicts a second plurality of markers represented in a second color channel from a second fluorophore, distinct from the single fluorophore.

Embodiment 116. The system of any of embodiments 113-115, wherein the plurality of training marker-separated fluorescence images depicts each marker in the plurality of markers in a respective color channel.

Embodiment 117. The system of any of embodiments 114-116, wherein in the marker-separated fluorescence image depicts a first marker of the plurality of markers in a first color channel and a second marker of the plurality of markers in a second color channel.

Embodiment 118. The system of any of embodiments 113-117, wherein the plurality of markers each indicates a structural or functional element of a sample depicted in the fluorescence image.

Embodiment 119. The system of embodiment 118, wherein the sample is a biological specimen.

Embodiment 120. The system of embodiment 119, wherein the biological specimen comprises tissues and/or cells.

Embodiment 121. The system of any of embodiments 113-120, wherein the trained machine-learning model comprises a modified cycle Generative Adversarial Network (CycleGAN).

Embodiment 122. The system of embodiment 121, wherein the modified CycleGAN is trained in one or more autoencoder modes and a translation mode.

Embodiment 123. The system embodiment 122, wherein the one or more autoencoder modes are trained based on an L1 loss function.

Embodiment 124. The system of embodiment 122 or embodiment 123,
wherein the modified CycleGAN comprises a generator model in a forward direction, a generator models in a reverse direction, and one or more discriminator models

Embodiment 125. The system of embodiment 124, wherein training in the translation mode is based on one or more cycle consistency loss functions based on inputs for the forward direction and outputs from the reverse direction.

Embodiment 126. The system of embodiment 124 or 125, wherein the generator model in the forward direction and/or the generator model in the reverse direction is a UNet generator.

Embodiment 127. The system of embodiment 126, wherein the UNet generator comprises an encoder, a plurality of bottleneck blocks, and a decoder.

Embodiment 128. The system of any of embodiments 124-127, wherein the generator model in the forward direction shares weights at one or more bottleneck blocks with the generator model in the reverse direction.

Embodiment 129. The system of any of embodiment 127 or 128, wherein at least one of the encoder, the plurality of bottleneck blocks, the decoder, and the one or more discriminators comprises one or more layers, and spectral normalization is used in training the one or more layers.

Embodiment 130. The system of embodiment 129, wherein spectral normalization comprises computing a lower bound approximation.

Embodiment 131. The system of any of embodiments 124-130, wherein the one or more discriminators are trained based on an adversarial loss function.

Embodiment 132. A system for enhancing a fluorescence image depicting a one or more markers and a background signal, comprising:
one or more processors; and
   a non-transitory memory coupled to the one or more processors comprising instructions that, when executed by the one or more processors, cause the one or more processors to:
   identify the background signal by inputting the fluorescence image into a trained machine-learning model,
      wherein the trained machine-learning model is trained with a plurality of training positive fluorescence images depicting the one or more markers and fluorescence background signal and a plurality of training negative fluorescence images depicting fluorescence background without the one or more markers, and
      wherein the plurality of training positive fluorescence images and the plurality of training negative fluorescence images are unpaired; and
   enhance the fluorescence image by removing the identified background signal form the fluorescence image.

Embodiment 133. The system of embodiment 132, wherein generating the enhanced fluorescence image comprises: obtaining an output background signal from the trained machine-learning model.

Embodiment 134. The system of embodiment 132 or 133, wherein the one or more marker each indicate a structural or functional element of a sample depicted in the fluorescence image.

Embodiment 135. The system of embodiment 134, wherein the sample is a biological specimen.

Embodiment 136. The system of embodiment 135, wherein the biological specimen comprises tissues and/or cells.

Embodiment 137. The system of any of embodiments 132-136, wherein the trained machine-learning model comprises a modified cycle Generative Adversarial Network (CycleGAN).

Embodiment 138. The system of embodiment 137, wherein the modified CycleGAN is trained in one or more autoencoder modes and a translation mode.

Embodiment 139. The system embodiment 138, wherein training in the one or more autoencoder modes is based on an L1 loss function.

Embodiment 140. The system of embodiment 138 or embodiment 139, wherein the modified CycleGAN comprises a generator model in a forward direction, a generator models in a reverse direction, and one or more discriminator models.

Embodiment 141. The system of embodiment 140, wherein training in the translation mode is based on one or more cycle consistency loss functions based on inputs for the forward direction and outputs from the reverse direction.

Embodiment 142. The system of embodiment 140 or 141, wherein the generator model in the forward direction and/or the generator model in the reverse direction is a UNet generator.

Embodiment 143. The system of embodiment 142, wherein the UNet generator comprises an encoder, a plurality of bottleneck blocks, and a decoder.

Embodiment 144. The system of any of embodiments 140-143, wherein the generator model in the forward direction shares weights at one or more bottleneck blocks with the generator model in the reverse direction.

Embodiment 145. The system of any of embodiment 143 or 144, wherein at least one of the encoder, the plurality of bottleneck blocks, the decoder, and the one or more discriminators comprises one or more layers, and spectral normalization is used in training the one or more layers.

Embodiment 146. The system of embodiment 145, wherein spectral normalization comprises computing a lower bound approximation.

Embodiment 147. The system of any of embodiments 140-146, wherein the one or more discriminators are trained based on an adversarial loss function.

Embodiment 148. A system for enhancing a fluorescence image depicting one or more markers, comprising:
one or more processors; and
   a non-transitory memory coupled to the one or more processors comprising instructions that, when executed by the one or more processors, cause the one or more processors to:
   receive the fluorescence image; and
   generate an enhanced fluorescence image by inputting the fluorescence image into a trained machine-learning model,
      wherein the machine-learning model is trained using a training dataset comprising a plurality of enhanced training fluorescence images depicting the one or more markers and a plurality of unenhanced training fluorescence images depicting the one or more markers,
      wherein the plurality of enhanced training fluorescence images and the plurality of unenhanced training fluorescence images are unpaired.

Embodiment 149. The system of embodiment 148, wherein generating the enhanced fluorescence image comprises: obtaining an output fluorescence image from the trained machine-learning model.

Embodiment 150. The system of any of embodiments 148-149, wherein the plurality of enhanced training fluorescence images have a first resolution and the plurality of unenhanced training fluorescence images have a second resolution, wherein the second resolution is higher than the first resolution.

Embodiment 151. The system any of embodiments 148-149, wherein the plurality of enhanced training fluorescence images have a first sharpness and the plurality of unenhanced training fluorescence images have a second sharpness, wherein the second sharpness is higher than the first sharpness.

Embodiment 152. The system of any of embodiments 148-151, wherein the plurality of enhanced training fluorescence images and the plurality of unenhanced training images have been obtained with:
(i) a first set of reagents and a second set of reagents, respectively;
(ii) a first concentration of reagents and a second concentration of reagents, respectively;
(iii) a first microscope and a second microscope, respectively;
(iv) a first plurality of microscopy settings and a second plurality of microscopy settings, respectively; or
(v) a first microscopy channel and a second microscopy channel, respectively.

Embodiment 153. The system of any of embodiments 148-152, wherein the one or more marker each indicate a structural or functional element of a sample depicted in the fluorescence image.

Embodiment 154. The system of embodiment 153, wherein the sample is a biological specimen.

Embodiment 155. The system of embodiment 153, wherein the biological specimen comprises tissues and/or cells.

Embodiment 156. The system of any of embodiments 148-155, wherein the trained machine-learning model comprises a modified cycle Generative Adversarial Network (CycleGAN).

Embodiment 157. The system of embodiment 156, wherein the modified CycleGAN is trained in one or more autoencoder modes and a translation mode.

Embodiment 158. The system embodiment 157, wherein training in the one or more autoencoder modes is based on minimizing an L1 loss function.

Embodiment 159. The system of embodiment 157 or embodiment 158, wherein the modified CycleGAN comprises a generator model in a forward direction, a generator models in a reverse direction, and one or more discriminator models.

Embodiment 160. The system of embodiment 159, wherein training in the translation mode is based on one or more cycle consistency loss functions based on inputs for the forward direction and outputs from the reverse direction.

Embodiment 161. The system of embodiment 159 or 160, wherein the generator model in the forward direction and/or the generator model in the reverse direction is a UNet generator.

Embodiment 162. The system of embodiment 161, wherein the UNet generator comprises an encoder, a plurality of bottleneck blocks, and a decoder.

Embodiment 163. The system of any of embodiments 159-162, wherein the generator model in the forward direction shares weights at one or more bottleneck blocks with the generator model in the reverse direction.

Embodiment 164. The system of any of embodiments 162 or 163, wherein at least one of the encoder, the plurality of bottleneck blocks, the decoder, and the one or more discriminators comprises one or more layers, and spectral normalization is used in training the one or more layers.

Embodiment 165. The system of embodiment 164, wherein spectral normalization comprises computing a lower bound approximation.

Embodiment 166. The system of any of embodiments 159-74165 wherein the one or more discriminators are trained based on an adversarial loss function.

Embodiment 167. A system of training a machine-learning model, the system comprising:
one or more processors; and
a non-transitory memory coupled to the one or more processors comprising instructions that, when executed by the one or more processors, cause the one or more processors to:
obtain a training dataset comprising a plurality of training single-channel fluorescence images and a plurality of training marker-separated fluorescence images, wherein the plurality of training single-channel fluorescence images and the plurality of training marker-separated fluorescence images are unpaired; and
train, based on the training data, the machine learning model configured to receive an fluorescence image depicting a plurality of markers represented in a single color channel from a single fluorophore and output a marker-separated fluorescence image, depicting each marker in the plurality of markers in a respective color channel.

Embodiment 168. The system of embodiment 167, wherein the machine-learning model comprises a modified cycle Generative Adversarial Network (CycleGAN).

Embodiment 169. The system of embodiment 168, wherein training the modified CycleGAN comprising training in one or more autoencoder modes and a translation mode.

Embodiment 170. The system embodiment 168, wherein training in the one or more autoencoder modes is based on an L1 loss function.

Embodiment 171. The method of embodiment 169 or embodiment 170, wherein the modified CycleGAN comprises a generator model in a forward direction, a generator models in a reverse direction, and one or more discriminator models.

Embodiment 172. The system of embodiment 171, wherein training in the translation mode is based on one or more cycle consistency loss functions based on inputs for the forward direction and outputs from the reverse direction.

Embodiment 173. The system of embodiment 171 or 172, wherein the generator model in the forward direction and/or the generator model in the reverse direction is a UNet generator.

Embodiment 174. The system of embodiment 173, wherein the UNet generator comprises an encoder, a plurality of bottleneck blocks, and a decoder.

Embodiment 175. The system of any of embodiments 171-174, wherein the generator model in the forward direction shares weights at one or more bottleneck blocks with the generator model in the reverse direction.

Embodiment 176. The system of any of embodiment 174 or 175, wherein at least one of the encoder, the plurality of bottleneck blocks, the decoder, and the one or more discriminators comprises one or more layers, and spectral normalization is used in training the one or more layers.

Embodiment 177. The system of embodiment 176, wherein spectral normalization comprises computing a lower bound approximation.

Embodiment 178. The system of any of embodiments 171-177, wherein training the one or more discriminators is based on an adversarial loss function.

Embodiment 179. A system of training a machine-learning model, the system comprising:
one or more processors; and
a non-transitory memory coupled to the one or more processors comprising instructions that, when executed by the one or more processors, cause the one or more processors to:
obtain a training dataset comprising a plurality of training positive fluorescence images depicting one or more markers and fluorescence background signal and a plurality of training negative fluorescence images depicting fluorescence background without the one or more markers,
   wherein the plurality of training positive fluorescence images and the plurality of training negative fluorescence images are unpaired; and
train, based on the training data, the machine learning model configured to receive a fluorescence image depicting the one or more markers and a background signal and identify the background signal.

Embodiment 180. The system of embodiment 179, wherein the machine-learning model comprises a modified cycle Generative Adversarial Network (CycleGAN).

Embodiment 181. The system of embodiment 180, wherein training the modified CycleGAN comprising training in one or more autoencoder modes and a translation mode.

Embodiment 182. The system embodiment 181, wherein training in the one or more autoencoder modes is based on an L1 loss function.

Embodiment 183. The system of embodiment 181 or embodiment 182, wherein the modified CycleGAN comprises a generator model in a forward direction, a generator models in a reverse direction, and one or more discriminator models.

Embodiment 184. The system of embodiment 183, wherein training in the translation mode is based on one or more cycle consistency loss functions based on inputs for the forward direction and outputs from the reverse direction.

Embodiment 185. The system of embodiment 183 or 184, wherein the generator model in the forward direction and/or the generator model in the reverse direction is a UNet generator.

Embodiment 186. The system of embodiment 185, wherein the UNet generator comprises an encoder, a plurality of bottleneck blocks, and a decoder.

Embodiment 187. The system of any of embodiments 183-186, wherein the generator model in the forward direction shares weights at one or more bottleneck blocks with the generator model in the reverse direction.

Embodiment 188. The system of any of embodiments 186 or 187, wherein at least one of the encoder, the plurality of bottleneck blocks, the decoder, and the one or more discriminators comprises one or more layers, and spectral normalization is used in training the one or more layers.

Embodiment 189. The system of embodiments 188, wherein spectral normalization comprises computing a lower bound approximation.

Embodiment 190. The system of any of embodiments 183-189, wherein training the one or more discriminators is based on an adversarial loss function.

Embodiment 191. A system of training a machine-learning model, the system comprising:
one or more processors; and
a non-transitory memory coupled to the one or more processors comprising instructions that, when executed by the one or more processors, cause the one or more processors to:
obtain a training dataset comprising a plurality of enhanced training fluorescence images depicting one or more markers and a plurality of unenhanced training fluorescence images depicting the one or more markers,
   wherein the plurality of enhanced training fluorescence images and the plurality of unenhanced training fluorescence images are unpaired; and
train, based on the training data, the machine learning model configured to receive a fluorescence image depicting the one or more markers and output an enhanced fluorescence image.

Embodiment 192. The system of embodiment 191, wherein the machine-learning model comprises a modified cycle Generative Adversarial Network (CycleGAN).

Embodiment 193. The system of embodiment 192, wherein training the modified CycleGAN comprising training in one or more autoencoder modes and a translation mode.

Embodiment 194. The system embodiment 193, wherein training in the one or more autoencoder modes is based on an L1 loss function.

Embodiment 195. The system of embodiment 193 or embodiment 194, wherein the modified CycleGAN comprises a generator model in a forward direction, a generator models in a reverse direction, and one or more discriminator models.

Embodiment 196. The system of embodiment 195, wherein training in the translation mode is based on one or more cycle consistency loss functions based on inputs for the forward direction and outputs from the reverse direction.

Embodiment 197. The system of embodiment 195 or 196, wherein the generator model in the forward direction and/or the generator model in the reverse direction is a UNet generator.

Embodiment 198. The system of embodiment 197, wherein the UNet generator comprises an encoder, a system plurality of bottleneck blocks, and a decoder.

Embodiment 199. The system of any of embodiments 195-198, wherein the generator model in the forward direction shares weights at one or more bottleneck blocks with the generator model in the reverse direction.

Embodiment 200. The system of any of embodiment 198 or 199, wherein at least one of the encoder, the plurality of bottleneck blocks, the decoder, and the one or more discriminators comprises one or more layers, and spectral normalization is used in training the one or more layers.

Embodiment 201. The system of embodiment 200, wherein spectral normalization comprises computing a lower bound approximation.

Embodiment 202. The system of any of embodiments 195-201, wherein training the one or more discriminators is based on an adversarial loss function.

What is claimed is:

1. A method for digitally identifying markers for a fluorescence image depicting a plurality of markers, comprising:
receiving the fluorescence image, wherein the plurality of markers are represented in a single color channel from a single fluorophore; and
identifying the plurality of markers in the fluorescence image by inputting the fluorescence image into a trained machine-learning model,
wherein the trained machine-learning model is trained with a plurality of training single-channel fluorescence images and a plurality of training marker-separated fluorescence images, and
wherein the plurality of training single-channel fluorescence images and the plurality of training marker-separated fluorescence images are unpaired.

2. The method of claim 1, wherein identifying the plurality of markers in the fluorescence image comprises displaying a marker-separated fluorescence image depicting the plurality of markers in a plurality of colors.

3. The method of claim 1, wherein the plurality of markers is a first plurality of markers, and wherein the fluorescence image depicts a second plurality of markers represented in a second color channel from a second fluorophore, distinct from the single fluorophore.

4. The method of claim 1, wherein the plurality of training marker-separated fluorescence images depicts each marker in the plurality of markers in a respective color channel.

5. The method of claim 1, wherein the plurality of markers each indicates a structural or functional element of a sample depicted in the fluorescence image.

6. The method of claim 5, wherein the sample is a biological specimen.

7. The method of claim 6, wherein the biological specimen comprises tissues and/or cells.

8. The method of claim 1, wherein the trained machine-learning model comprises a modified cycle Generative Adversarial Network (CycleGAN).

9. The method of claim 8, wherein the modified CycleGAN is trained in one or more autoencoder modes and a translation mode.

10. The method claim 9, wherein training in the one or more autoencoder modes is based on minimizing an L1 loss function.

11. The method of claim 9, wherein the modified CycleGAN comprises a generator model in a forward direction, a generator models in a reverse direction, and one or more discriminator models.

12. The method of claim 11, wherein training in the translation mode comprises minimizing one or more cycle consistency loss functions based on inputs for the forward direction and outputs from the reverse direction.

13. The method of claim 11, wherein the generator model in the forward direction and/or the generator model in the reverse direction is a UNet generator.

14. The method of claim 13, wherein the UNet generator comprises an encoder, a plurality of bottleneck blocks, and a decoder.

15. The method of claim 11, wherein the generator model in the forward direction shares weights at one or more bottleneck blocks with the generator model in the reverse direction.

16. The method of claim 14, wherein at least one of the encoder, the plurality of bottleneck blocks, the decoder, and the one or more discriminators comprises one or more layers, and spectral normalization is used in training the one or more layers.

17. The method of claim 16, wherein spectral normalization comprises computing a lower bound approximation.

18. The method of claim 11, wherein the one or more discriminators are trained based on an adversarial loss function.

19. A method of training a machine-learning model, the method comprising:
obtaining training dataset comprising a plurality of training single-channel fluorescence images and a plurality of training marker-separated fluorescence images, wherein the plurality of training single-channel fluorescence images and the plurality of training marker-separated fluorescence images are unpaired; and
training, based on the training data, the machine learning model configured to receive an fluorescence image depicting a plurality of markers represented in a single color channel from a single fluorophore and output a marker-separated fluorescence image, depicting each marker in the plurality of markers in a respective color channel.

20. A system comprising:
one or more processors; and
a non-transitory memory coupled to the one or more processors comprising instructions that, when executed by the processor, cause the processor to:
receive the fluorescence image, wherein the plurality of markers are represented in a single color channel from a single fluorophore; and
identify the plurality of markers in the fluorescence image by inputting the fluorescence image into a trained machine-learning model,
wherein the trained machine-learning model is trained with a plurality of training single-channel fluorescence images and a plurality of training marker-separated fluorescence images, and
wherein the plurality of training single-channel fluorescence images and the plurality of training marker-separated fluorescence images are unpaired.
